(19) United States
(12) Patent Application Publication
(10) Pub. No.: US 2026/0362493 A1
(43) Pub. Date: Nov. 12, 2026

(54) CONDITIONAL INCLUSION OF FEATURE COMBINATION IN RA REPORT

(71) Applicant: TELEFONAKTIEBOLAGET LM ERICSSON (PUBL), Stockholm (SE)

(72) Inventors: Ali Parichehrehteroujeni, LINKÖPING (SE); Johan Rune, LIDINGÖ (SE); Tahmineh Torabian Esfahani, SOLLENTUNA (SE)

(21) Appl. No.: 19/118,616

(22) PCT Filed: Nov. 3, 2023
(86) PCT No.: PCT/IB2023/061124

§ 371 Date: Apr. 4, 2025

Related U.S. Application Data
(60) Provisional application No. 63/422,276, filed on Nov. 3, 2022.

(51) Int. Cl. H04W 74/0833

(52) U.S. Cl. CPC H04W 74/0833

(57) ABSTRACT

Methods and systems are described for RA Optimization such as by improving the RA report as a basis for RA configuration optimization. Certain proposed embodiments include applying, to the new feature combination information agreed to be included in the RA report, a principle where some information can be deduced without explicit inclusion in the RA Report IE. One aspect is to omit one of the triggering feature combinations and the used feature combination information in the RA report when the two feature combinations are identical. Certain embodiments can also include lean ways to capture, in the RA report, cases where the triggering feature combination changes during the course of a random access procedure. Certain embodiments enable more information, covering new features, to be included in the RA report in a data-efficient manner.

### CROSS REFERENCE TO RELATED INFORMATION

This application claims the benefit of United States of America priority application No. 63/422,276 filed on Nov. 3, 2022, titled “Conditional inclusion of feature combination in RA report.”

### TECHNICAL FIELD

The present disclosure generally relates to the technical field of wireless communications and more particularly to cell reselection techniques.

### BACKGROUND

### RACH Configuration in NR

SIB1 (System Information Block 1), which is part of the system information broadcast in a cell includes configuration parameters that informs the UE about relevant aspects of the RA (random access) related resources and the UE's (user equipment) expected behavior in the context of random access procedures. The RA related configuration mainly includes:
PRACH (Physical Random Access Channel) occasion configuration in the time domain and the frequency domain.
Msg1/MsgA subcarrier spacing.
RA preamble range.
SSB (Synchronization Signal Block) to RACH (Random Access Channel) occasion and preamble set mapping.
Some optional RA preamble partitioning information.
Various parameters related to the UE's behavior during the random access procedure, e.g. RA type (i.e. 4-step RA or 2-step RA) selection RSRP (Reference Signal Received Power) threshold, SSB selection RSRP threshold, RA response window, MsgB response window, contention resolution timer, power ramping step, number of MsgA transmissions before switch to 4-step RA, maximum number of RA preamble transmissions before abandoning the RA procedure, etc.
PUSCH (Physical Uplink Shared Channel) configuration for the PUSCH part of MsgA in 2-step RA.

The IEs that are the most relevant for the NR (New Radio) RACH configuration are RACH-ConfigGeneric, RACH-ConfigCommon, RACH-ConfigGenericTwoStep-r16 and RACH-ConfigCommonTwoStep-r16. The two former configure 4-step RA aspects, while the two latter configure 2-step RA aspects. For 2-step RA, the IEs (information element) MsgA-ConfigCommon-r16 and MsgA-PUSCH-Config-r16 are also relevant. These IEs are all included in SIB1 in the broadcast system information (provided that the concerned RA type is supported in the cell). In addition, in conjunction with handover (reconfiguration with sync), a UE can receive RACH configuration for a target cell via dedicated signaling (in the handover command (i.e. RRCReconfiguration (Radio Resource Control Reconfiguration) from the target gNB). This RACH configuration is then conveyed in a RACH-ConfigDedicated IE.

The ASN.1 (Abstract Syntax Notation One) definitions of these IEs, as well as their respective associated field descriptions and conditional presence explanations, are copied from 3GPP TS 38.331 version 17.2.0 and shown in FIGS. 1-19. FIG. 1 shows the RACH-ConfigGeneric information element. FIG. 2 shows RACH-ConfigGeneric field descriptions. FIG. 3 shows a RACH-ConfigCommon information element. FIGS. 4 and 5 show RACH-ConfigCommon field descriptions. FIG. 6 shows a RACH-ConfigGenericTwoStepRA information element. FIGS. 7 and 8 show RACH-ConfigGenericTwoStepRA field descriptions. FIG. 9 shows a RACH-ConfigCommonTwoStepRA information element. FIGS. 10 and 11 show RACH-ConfigCommonTwoStepRA field descriptions. FIG. 12 shows a MsgA-ConfigCommon information element and MsgA-ConfigCommon field descriptions. FIG. 13 shows a MsgA-PUSCH-Config information element. FIG. 14 shows MsgA-PUSCH-Config field descriptions. FIG. 15 shows MsgA-PUSCH-Resource field descriptions. FIG. 16 shows MsgA-DMRS-Config (MsgA Demodulation Reference Signal Configuration) field descriptions. FIG. 17 shows a RACH-ConfigDedicated information element. FIG. 18 shows CFRA-CSIRS-Resource (Contention Free Random Access-Channel State Information Reference Signal Resource) field descriptions, CFRA field descriptions, and CFRA-SSB-Resource (CFRA Synchronization Signal Block Resource) field descriptions. FIG. 19 shows CFRA-TwoStep field descriptions, and RACH-ConfigDedicated field descriptions.

### 4-Step RA Procedure in NR

A 4-step approach is used for the random access procedure in NR, see FIG. 20. In this approach, the UE detects a synchronization signal (SS) and decodes the broadcasted system information, followed by transmitting a PRACH preamble (message 1) in the uplink. The gNB (base station in NR) replies with a RAR (Random Access Response, message 2). The UE then transmits a UE identification (message 3) on PUSCH (Physical Uplink Shared Channel).

The UE transmits PUSCH (message 3) after receiving a timing advance command in the RAR, allowing PUSCH to be received with a timing accuracy within the cyclic prefix. Without this timing advance, a very large CP (cyclic prefix) would be needed in order to be able to demodulate and detect PUSCH, unless the system is applied in a cell with very small distance between UE and eNB (Evolved NodeB, or base station in LTE (Long Term Evolution)). Since NR will also support larger cells with a need for providing a timing advance to the UE the 4-step approach is needed for random access procedure.

### NR Rel-15 PRACH Configuration

In NR, the time and frequency resource on which a PRACH preamble is transmitted is defined as a PRACH occasion.

For the present disclosure, the PRACH occasion is also called RACH occasion, or RA occasion, or in short RO. And the RO used for the transmission of the preambles in 2-step RA is called 2-step RO, while the RO used for the transmission of the preambles in 4-step RA is called 4-step RO.

The time resources and preamble format for PRACH transmission is configured by a PRACH configuration index, which indicates a row in a PRACH configuration table specified in TS 38.211 Tables 6.3.3.2-2, 6.3.3.2-3, 6.3.3.2-4 for FR1 (frequency range 1) paired spectrum, FR1 unpaired spectrum and FR2 (frequency range 2) with unpaired spectrum, respectively.

Part of the Table 6.3.3.2-3 for FR1 unpaired spectrum for PRACH preamble format 0 is copied in FIG. 21, where the value of x indicates the PRACH configuration period in number of system frames. The value of y indicates the system frame within each PRACH configuration period on which the PRACH occasions are configured. For instance, if y is set to 0, then, it means PRACH occasions only configured in the first frame of each PRACH configuration period. The values in the column “subframe number” tells on which subframes are configured with PRACH occasion. The values in the column “starting symbol” is the symbol index.

In case of TDD (time division duplex), semi-statically configured DL (downlink) parts and/or actually transmitted SSBs can override and invalidate some time-domain PRACH occasions defined in the PRACH configuration table. More specifically, PRACH occasions in the UL (uplink) part are always valid, and a PRACH occasion within the X part is valid as long as it does not precede or collide with an SSB in the RACH slot and it is at least N symbols after the DL part and the last symbol of an SSB. N is 0 or 2 depending on PRACH format and subcarrier spacing.

In the frequency domain, NR supports multiple frequency-multiplexed PRACH occasions on the same time-domain PRACH occasion. This is mainly motivated by the support of analog beam sweeping in NR such that the PRACH occasions associated to one SSB are configured at the same time instance but different frequency locations. The number of PRACH occasions FDMed in one time domain PRACH occasion, can be 1, 2, 4, or 8. FIG. 22 gives an example of a PRACH occasion configuration in NR.

In NR Rel-15, there are up to 64 sequences that can be used as random-access preambles per PRACH occasion in each cell. The RRC parameter totalNumberOfRA-Preambles determines how many of these 64 sequences are used as random-access preambles per PRACH occasion in each cell. The 64 sequences are configured by including firstly all the available cyclic shifts of a root Zadoff-Chu sequence, and secondly in the order of increasing root index, until 64 preambles have been generated for the PRACH occasion.

### NR Rel-15 Association Between SSB and PRACH Occasion

NR Rel-15 supports one-to-one, one-to-many, and many-to-one association between SSB and PRACH Occasions, as illustrated in FIG. 23 and FIG. 24.

When a UE detects one best SSB beam, a preamble in the set of one or more preambles mapped to this SSB will be selected for the random access, then when the gNB detects the preamble, the best SSB beam for this UE is known indirectly so that best beams can be used for transmitting signals to or receiving signals from this UE.

The preambles associated to each SSB are configured by the two RRC parameters in the RACH-ConfigCommon: ssb-perRACH-OccasionAndCB-PreamblesPerSSB and totalNumberOfRA-Preambles.

The detailed mapping rule is specified in TS 38.213 section 8.1, as follows:
A UE is provided a number N of SS/PBCH (Synchronization Signal/Physical Broadcast Channel) blocks associated with one PRACH occasion and a number R of contention-based preambles per SS/PBCH block per valid PRACH occasion by ssb-perRACH-OccasionAndCB-PreamblesPerSSB. If N<1 one SS/PBCH block is mapped to 1/N consecutive valid PRACH occasions and R contention based preambles with consecutive indexes associated with the SS/PBCH block per valid PRACH occasion start from preamble index 0. If N≥1, R contention based preambles with consecutive indexes associated with SS/PBCH block n, 0≤n≤N−1, per valid PRACH occasion start from preamble index

$$n \cdot {N}_{preamble}^{total} / N where {N}_{preamble}^{total}$$

is provided by totalNumberOfRA-Preambles and is an integer multiple of N.

In other words, the mapping between SSB and preambles is done by consecutively associating M preambles to each SSB, where M=/, and as illustrated in FIG. 25 the preambles are taken in the following order:
First, in increasing order of preamble indexes within a single PRACH occasion;
Second, in increasing order of frequency resource indexes for frequency multiplexed PRACH occasions; and
Third, in increasing order of time.

For each SSB, the associated preambles per PRACH occasion are further divided into two sets for CBRA (Contention Based Random Access) and CFRA. The number of CB (code block) preambles per SSB per PRACH occasion is signaled by the RRC (Radio Resource Control) parameter #CB-preambles-per-SSB. Preamble indices for CBRA and CFRA are mapped consecutively for one SSB in one PRACH occasion, as shown in FIG. 26.

### The 2-Step RA Procedure in 3GPP Release 16

A 2-step RACH work item has been approved in the RAN1 #82 plenary meeting. Completing the initial access in only two steps is illustrated in FIG. 27:
Step 1: UE sends a message A (abbreviated “MsgA” or “msgA”—these two abbreviations can be used interchangeably in the present disclosure) including random access preamble together with higher layer data such as RRC connection request possibly with some small payload on PUSCH;
Step 2: The gNB sends RAR (random access response) (actually called message B (abbreviated “MsgB” or “msgB”—these two abbreviations are used interchangeably in this document)) including UE identifier assignment, timing advance information, and contention resolution message etc.

### MsgA Preamble Configuration

The RACH occasions for 2-step RACH can be either separately configured (also known as Type-2 random access procedure with separate configuration of PRACH occasions with Type-1 random access procedure) or are shared with 4-step RACH (also known as Type-2 random access procedure with common configuration of PRACH occasions with Type-1 random access procedure) in which case different set of preamble IDs will be used.

For Type-2 random access procedure with common configuration of PRACH occasions with Type-1 random access procedure, a UE is provided a number N of SS/PBCH blocks associated with one PRACH occasion by ssb-perRACH-OccasionAndCB-PreamblesPerSSB and a number Q of contention based preambles per SS/PBCH block per valid PRACH occasion by MsgA-CB-PreamblesPerSSB. The PRACH transmission can be on a subset of PRACH occasions associated with a same SS/PBCH block index for a UE provided with a PRACH mask index by MsgA-ssb-sharedRO-MaskIndex. An example of the SSB to RO mapping and the preamble allocation is provided in FIG. 28. Note that only one preamble group is assumed in this example.

For Type-2 random access procedure with separate configuration of PRACH occasions with Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB-MsgA when provided; otherwise, by ssb-perRACH-OccasionAndCB-PreamblesPerSSB. Since the SSB to RO mapping and the preamble allocation are independently configured, the example provided for 4-step RACH in FIG. 28 is also valid for this case of 2-step RACH except that the parameters are separately configured for 2-step RACH.

### MsgA PUSCH Configuration

A PUSCH occasion (PO) is defined as the time frequency resource used for one PUSCH transmission. For one MsgA PUSCH occasion, one or more DMRS resources can be configured, one of which will be selected for each PUSCH transmission with in the PUSCH occasion. The term PUSCH resource unit (PRU) is used in this IvD to define a PUSCH occasion with one DMRS resource.

A set of PUSCH occasions are configured per MsgA PUSCH configuration which are relative to and mapped by a group of preambles in a set of ROs in one PRACH slot. A mapping between one or multiple PRACH preambles and a PUSCH occasion associated with a DMRS resource is according to the mapping order as described below.

Each consecutive number of N_{preamble} preamble indexes from valid PRACH occasions in a PRACH slot can be arranged as:
first, in increasing order of preamble indexes within a single PRACH occasion;
second, in increasing order of frequency resource indexes for frequency multiplexed PRACH occasions;
third, in increasing order of time resource indexes for time multiplexed PRACH occasions within a PRACH slot.

These are then mapped to a valid PUSCH occasion and the associated DMRS resource:
first, in increasing order of frequency resource indexes f_{id} for frequency multiplexed PUSCH occasions;
second, in increasing order of DMRS resource indexes within a PUSCH occasion, where a DMRS resource index DMRS_{id} is determined first in an ascending order of a DMRS port index and second in an ascending order of a DMRS sequence index;
third, in increasing order of time resource indexes t_{id} for time multiplexed PUSCH occasions within a PUSCH slot;
fourth, in increasing order of indexes for Nₛ PUSCH slots.

Here, N_{preamble}=ceil (T_{preamble}/T_{PUSCH}), T_{preamble} is a total number of valid PRACH occasions per association pattern period multiplied by the number of preambles per valid PRACH occasion provided by MsgA-PUSCH-PreambleGroup, and T_{PUSCH} is a total number of valid PUSCH occasions per PUSCH configuration per association pattern period multiplied by the number of DMRS resource indexes per valid PUSCH occasion provided by MsgA-DMRS-Config.

### RA Partitioning to Support Feature Signaling

For some features there is a need for the UE to provide an indication to the network already in the random access procedure. For example, a UE may need to indicate that the UE is of a certain type or that the UE wants to apply a feature. For example, 3GPP has concluded that a UE of reduced capabilities (sometimes called RedCap UE) can benefit from indicating to the network during the random access procedure that the UE is a RedCap UE rather than a non-RedCap UE. Another example of such a feature is an indication from the UE whether the UE wants to use a Small Data Transmission (SDT) feature.

To provide such an indication during the random access procedure, it is discussed that the Random Access resources should be partitioned so that one partition can be dedicated to RedCap UEs and another for non-RedCap UEs.

The system may support several features which require indications during the random access procedure. For example, both support RedCap (reduced capability) and SDT (small data transmission). That means that there will be several partitions to indicate combinations of features, e.g.:
one partition for non-RedCap UEs which do not want to apply SDT;
one partition for non-RedCap UEs which do want to apply SDT;
one partition for RedCap UEs which do not want to apply SDT;
one partition for RedCap UEs which do want to apply SDT.

A partition of a RA resources may be realized as a partition of the preamble range available in the cell. Furthermore, such a preamble partition may be valid in only a subset of the RA occasions. That is, one set of preambles is dedicated for one feature (or combination of features), optionally limited to a certain subset of the RA occasions. Similarly, another set of preambles is dedicated for another feature (or another combination of features), optionally limited to a certain subset of the RA occasions.

If the network supports such preamble-based signaling of feature combinations (where a feature combination may consist of one or more features) in a certain cell, the configuration of these mechanisms is indicated in SIB1 in the system information broadcast in the cell (in FeatureCombinationPreambles-r17 IEs in the RACH-ConfigCommon IE and (if present) in the RACH-ConfigCommonTwoStepRA-r16 IE). The FeatureCombinationPreambles-r17 IE configures one feature combination preamble partition, and FIG. 29 displays its ASN.1 code (and field descriptions in FIG. 30) in 3GPP TS 38.331 version 17.2.0.

As can be seen in the above, the FeatureCombinationPreambles-r17 includes a FeatureCombination-r17 IE. The FeatureCombination-r17 indicates the combination of features that the FeatureCombinationPreambles-r17 applies to. The ASN.1 code is show in FIG. 31 (and field descriptions in FIGS. 32A-32C) of the FeatureCombination-r17 IE in 3GPP TS 38.331 version 17.2.0.

SIB1 also includes a priority (in the form of a FeaturePriority-r17 IE) for each feature that maps to at least one FeatureCombinationPreambles-r17 IE. These priorities are used to determine which RA preamble partition (i.e. which FeatureCombinationPreambles-r17 IE) the UE shall use when a triggering feature maps to more than one RA preamble partition (i.e. more than one FeatureCombinationPreambles-r17 IE) or when no configured RA preamble partition (i.e. no FeatureCombinationPreambles-r17 IE) is associated with a feature combination (i.e. a FeatureCombination-r17 IE) that includes all the features of the feature combination that triggered the RA procedure in the UE.

If a UE that intends to initiate a random access procedure needs to (or would benefit from) signal to the network the feature or feature combination that triggered the random access, the UE selects a preamble from the RA preamble partition associated with a feature combination (provided that such RA preamble range partitioning is configured in the cell) including the triggering feature (or triggering feature combination). If a combination of features triggered the random access procedure in the UE, and there is no configured RA partition that is associated with a feature combination that includes all the UE's triggering features, or if the feature or feature combination that triggered the random access procedure in the UE maps to more than one configured RA partition, the UE checks the priorities associated with the triggering features and selects RA preamble partition based on these priorities.

### RA Optimization

The RACH configuration has critical impacts on user experience and overall network performance. The RACH collision probability, and therefore access setup delays, data resuming delays from the UL unsynchronized state, handover delays, transition delays from RRC_INACTIVE, and beam failure recovery delays are all affected by the RA configuration, including RACH settings and preamble index configuration. In addition, performing RA on the most suitable downlink beam is also important and will avoid unnecessary power ramping and failed RA attempts. This is beneficial both for the network as well as for the attempting device; it allows to avoid unnecessary interference in the network and, also, reduce the experienced delay and UE energy consumption. In NR, a new feature allows UE to use dedicated RA resource depending on a number of factors, such as the service that triggered the RA procedure, which leads to more complex behavior.

The setting of RA parameters depends on a multitude of factors, e.g.:
the uplink inter-cell interference from the Physical Uplink Shared Channel (PUSCH);
RACH load (call arrival rate, HO rate, tracking area update, RRC_INACTIVE/RRC_IDLE to RRC_CONNECTED state transition rate, the frequency of requests for Other SI, the beam failure recovery rate, inactivity timer setting, traffic pattern and population under the cell coverage as it affects the UL synchronization states and hence the need to use random access);
uplink (UL) and supplementary uplink (SUL) imbalances;
PUSCH load;
the cubic metric of the preambles allocated to a cell;
whether the cell is in high-speed mode or not;
uplink (UL) and downlink (DL) imbalances.

The targets of RA optimization are indicated as follows:
Minimize access delays for the UEs under the coverage of popular SSBs;
Minimize the delays for the UEs to request Other SI;
Minimize the imbalance of UEs' access delays on uplink (UL) and supplementary uplink (SUL) channel;
Minimize the beam failure recovery delays for the UEs in RRC_CONNECTED state;
Minimize the failed/unnecessary RA attempts (consuming RA resource) before success.

Consequently, the RA optimization function will attempt to automatically set several parameters related to the performance of RA. Automatic RA parameter settings can be enabled by collecting the RA report from UE and by PRACH parameters exchange between gNBs.

The setting of RA parameters that can be optimized are e.g.:
RACH configuration (resource unit allocation);
RA preamble split (among dedicated, group A, group B);
RA backoff parameter value;
RA transmission power control parameters.

As a minimum, RA optimization is realized by UE providing RA related information to the NG-RAN (Next Generation Radio Access Network) node, and by exchange of PRACH configuration of normal UL carrier and SUL carrier between NG-RAN nodes.

For CU-DU (central unit-distributed unit) architecture, gNB-DU should be allowed to report its RA configuration per cell to the gNB-CU, and the gNB-CU should be allowed to signal the RA configuration per served cell to neighboring NG-RAN nodes. This allows NG-RAN nodes to identify whether RA configurations of neighboring cells are optimized or whether changes are needed in order to achieve a better RA coordination between neighboring cells.

Upon receiving the polling message requesting RA report, e.g. UEInformationRequest RRC message, from the NG-RAN node (potentially gNB-CU of the current serving cell), UE reports RA information within a UEInformationResponse RRC message. The gNB-CU and gNB-DU take into account the RA report and other node information, to achieve an optimized RA configuration.

The content of the RA report includes the following:
Cell ID;
Purpose of the RA;
Various RA configuration parameters (including 4-step RA configuration and/or 2-step RA configuration parameters);
Indexes of the SSBs and number of RA preambles sent on each tried SSB listed in chronological order of attempts;
The frequency (NR ARFCN (Absolute Radio Frequency Channel Number)) of tried SSBs;
The beam quality of each tried SSB (e.g., beam level measurement during RA attempts such as BRSRP (beam reference signal received power), BRSRQ (beam reference signal received quality), BSINR (beam signal to interference and noise ratio));
Indication whether the selected SSB is above or below the rsrp-ThresholdSSB threshold;
Elapsed time from the last measurement prior to the beam selection time;
Number of RA preambles sent on SUL;
Number of RA preambles sent on NUL;
Total number of Contention Free Random Access (CFRA) attempts and Contention Based Random Access (CBRA) attempts;
4-step RA attempts and 2-step RA attempts;
Fallbacks from 2-step RA to 4-step RA;
Whether contention was detected for each RA attempt.

Furthermore, at the RAN2 #119bis meeting, it was agreed to further include the following information in the RA report:
Feature or combination of features that triggered the RA in the UE (applicable if the UE used a RA preamble signaling certain feature support);
Used feature combination (i.e. the feature combination associated with the RA preamble partition the UE selected a RA preamble from—applicable if the UE used a RA preamble signaling certain feature support).

The above RA report should also be applied to the Secondary Node (SN) for the MR-DC (Multi-RAT Dual Connectivity) case.

The RA report may be requested by the network via the UE Information procedure in RRC (section 5.7.10.3 of TS 38.331 version 17.2.0), in the case where a RA procedure was successful. Further, what information is included by the UE in the RA report is specified in section 5.7.10.5 of TS 38.331 version 17.2.0.

In 3GPP TS 38.331 version 17.2.0, the RA report is specified in ASN.1 code in the form of the RA-Report-r16 IE. It is part of the ASN.1 code for the UEInformationResponse message. The parts of this ASN.1 code (and associated field descriptions) that are relevant for the RA report are shown in FIGS. 32A-32C (note that most of the ASN.1 code and field descriptions have been omitted, because they are not relevant in the context of this disclosure). FIG. 33 shows UEInformationResponse-IEs field descriptions and RA-InformationCommon field descriptions. FIGS. 34A and 34B show RA-Report field descriptions.

### SUMMARY

One embodiment under the present disclosure comprises a method performed by a UE for optimizing RA configuration. The method comprises detecting a trigger condition to initiate an RA procedure, the trigger condition based on a triggering feature combination comprising a first one or more features; and selecting an RA preamble from an RA preamble partition, the RA preamble partition associated with a used feature combination comprising a second one or more features. The method further comprises transmitting a RA report to a network node, wherein when the triggering feature combination and the used feature combination are the same then one of them is omitted from the RA report, and if the triggering feature combination and the used feature combination are different then they are both included in the RA report.

Another embodiment of a method under the present disclosure is a method performed by a network node for optimizing RA configuration. The method comprises receiving an RA report from a UE upon the occurrence of a trigger condition, wherein the trigger condition is based on a triggering feature combination comprising a first one or more features and wherein the RA report comprises a RA preamble partition associated with a used feature combination comprising a second one or more features, wherein when the triggering feature combination and the used feature combination are the same then one of them is omitted from the RA report, and if the triggering feature combination and the used feature combination are different then they are both included in the RA report.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 shows the RACH-ConfigGeneric information element;

FIG. 2 shows RACH-ConfigGeneric field descriptions;

FIG. 3 shows a RACH-ConfigCommon information element;

FIG. 4 shows RACH-ConfigCommon field descriptions;

FIG. 5 shows RACH-ConfigCommon field descriptions;

FIG. 6 shows a RACH-ConfigGenericTwoStepRA information element;

FIG. 7 shows RACH-ConfigGenericTwoStepRA field descriptions;

FIG. 8 shows RACH-ConfigGenericTwoStepRA field descriptions;

FIG. 9 shows a RACH-ConfigCommonTwoStepRA information element;

FIG. 10 shows RACH-ConfigCommonTwoStepRA field descriptions;

FIG. 11 shows RACH-ConfigCommonTwoStepRA field descriptions;

FIG. 12 shows a MsgA-ConfigCommon information element and MsgA-ConfigCommon field descriptions;

FIG. 13 shows a MsgA-PUSCH-Config information element;

FIG. 14 shows MsgA-PUSCH-Config field descriptions;

FIG. 15 shows MsgA-PUSCH-Resource field descriptions;

FIG. 16 shows MsgA-DMRS-Config (MsgA Demodulation Reference Signal Configuration) field descriptions;

FIG. 17 shows a RACH-ConfigDedicated information element;

FIG. 18 shows CFRA-CSIRS-Resource (Contention Free Random Access-Channel State Information Reference Signal Resource) field descriptions, CFRA field descriptions, and CFRA-SSB-Resource (CFRA Synchronization Signal Block Resource) field descriptions;

FIG. 19 shows CFRA-TwoStep field descriptions, and RACH-ConfigDedicated field descriptions;

FIG. 20 shows a 4-step approach for a random access procedure in NR;

FIG. 21 shows part of the Table 6.3.3.2-3 for FR1 unpaired spectrum for PRACH preamble format 0;

FIG. 22 gives an example of a PRACH occasion configuration in NR;

FIG. 23 shows one-to-one association between SSB and PRACH Occasions under NR Rel-15;

FIG. 24 shows many-to-one association between SSB and PRACH Occasions under NR Rel-15;

FIG. 25 illustrates the mapping between SSB and preambles by consecutively associating M preambles to each SSB;

FIG. 26 illustrates preamble indices for CBRA and CFRA that are mapped consecutively for one SSB in one PRACH occasion;

FIG. 27 shows a 2-step RACH initial access from the RAN1 #82 plenary meeting;

FIG. 28 shows an example of the SSB to RO mapping and preamble allocation;

FIG. 29 shows ASN.1 code for a FeatureCombinationPreambles-r17 IE that configures one feature combination preamble partition in 3GPP TS 38.331 version 17.2.0;

FIG. 30 shows field descriptions for a FeatureCombinationPreambles-r17 IE that configures one feature combination preamble partition in 3GPP TS 38.331 version 17.2.0;

FIG. 31 shows the ASN.1 code for a FeatureCombination-r17 IE in 3GPP TS 38.331 version 17.2.0;

FIG. 32 shows the field descriptions for a FeatureCombination-r17 IE in 3GPP TS 38.331 version 17.2.0;

FIG. 33 shows UEInformationResponse-IEs field descriptions and RA-InformationCommon field descriptions;

FIGS. 34A-34B show RA-Report field descriptions;

FIG. 35 shows an example under the present disclosure of inclusion of feature combination information at the top level of the RA-Report-r16 IE based on ASN.1 code in 3GPP TS 38.331 version 17.2.0;

FIG. 36 shows an example under the present disclosure of inclusion of feature combination information in the RA-InformationCommon-r16 IE based on ASN.1 code in 3GPP TS 38.331 version 17.2.0;

FIG. 37 shows an example under the present disclosure of inclusion of feature combination information in the PerRAAttemptInfo-r16 IE based on ASN.1 code in 3GPP TS 38.331 version 17.2.0;

FIG. 38 shows an example method embodiment under the present disclosure;

FIG. 39 shows a schematic of a communication system embodiment under the present disclosure;

FIG. 40 shows a schematic of a user equipment embodiment under the present disclosure;

FIG. 41 shows a schematic of a network node embodiment under the present disclosure;

FIG. 42 shows a schematic of a host embodiment under the present disclosure;

FIG. 43 shows a schematic of a virtualization environment embodiment under the present disclosure; and

FIG. 44 shows a schematic representation of an embodiment of communication amongst nodes, hosts, and user equipment under the present disclosure.

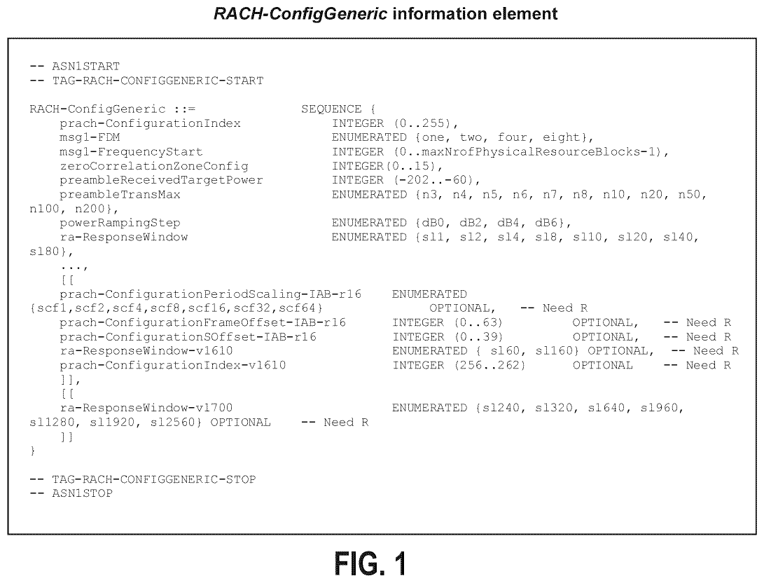

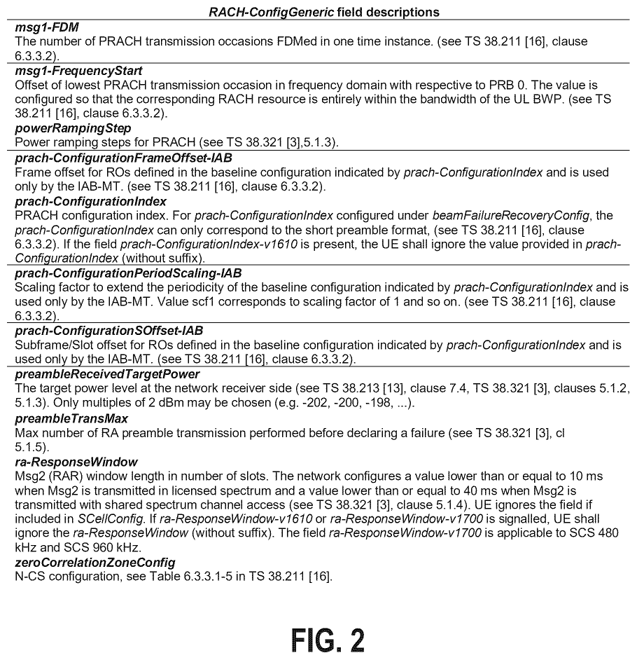

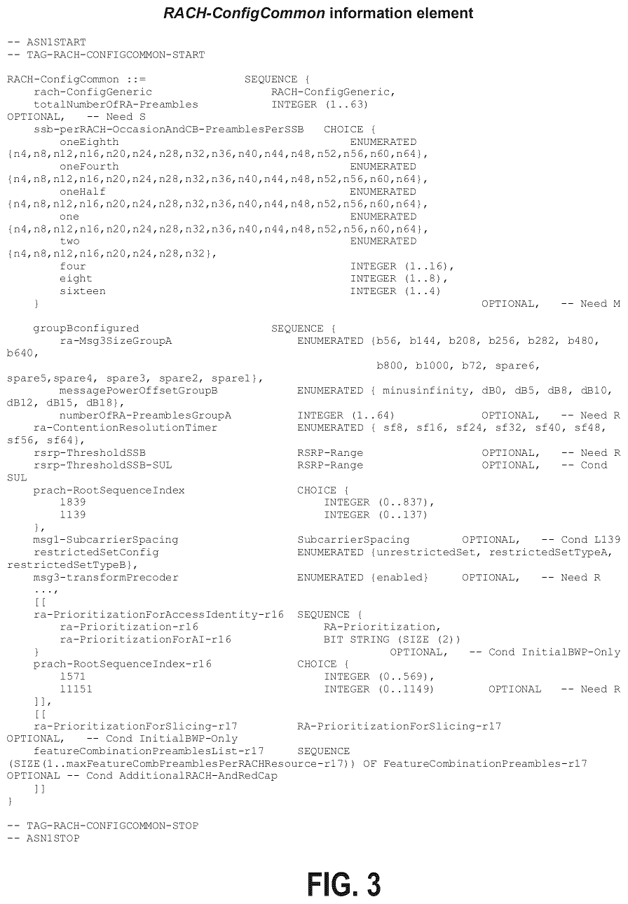

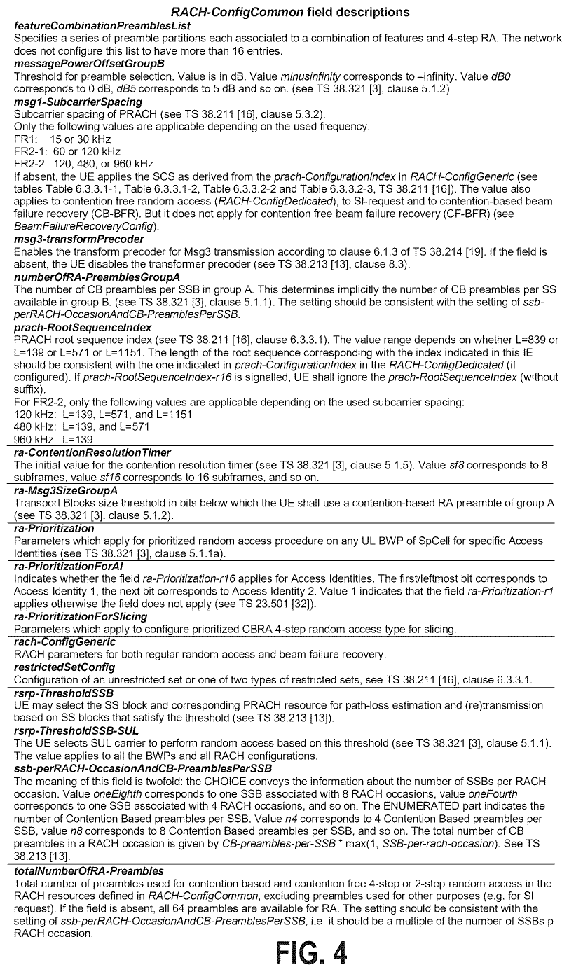

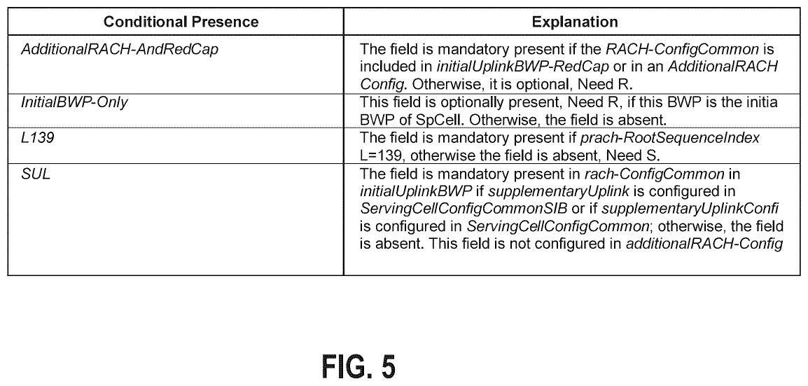

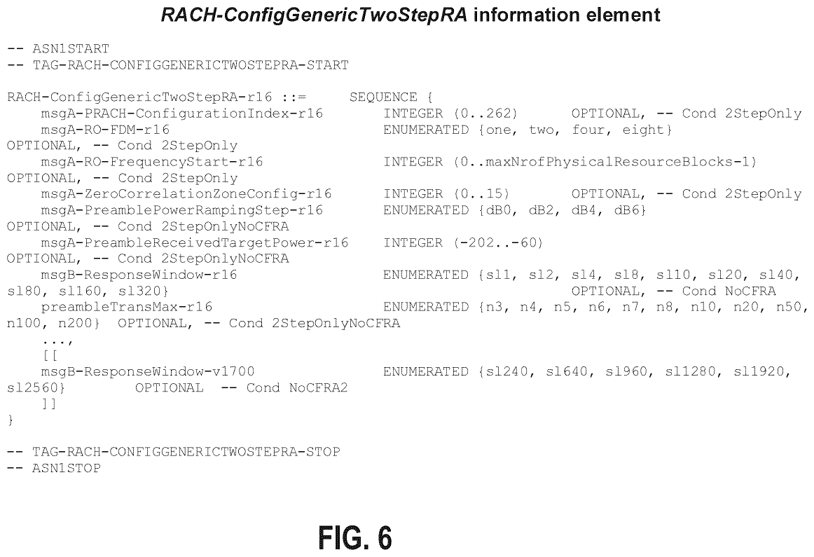

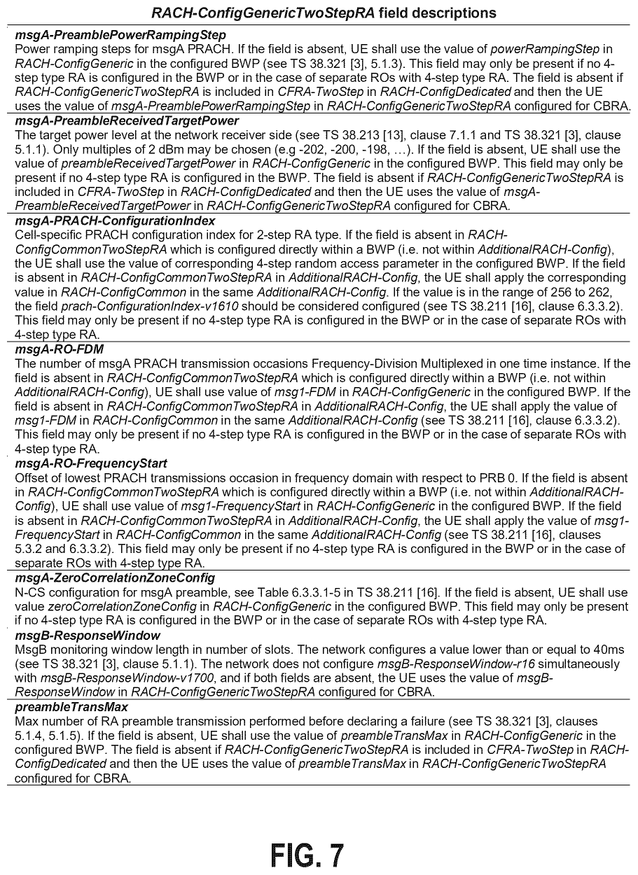

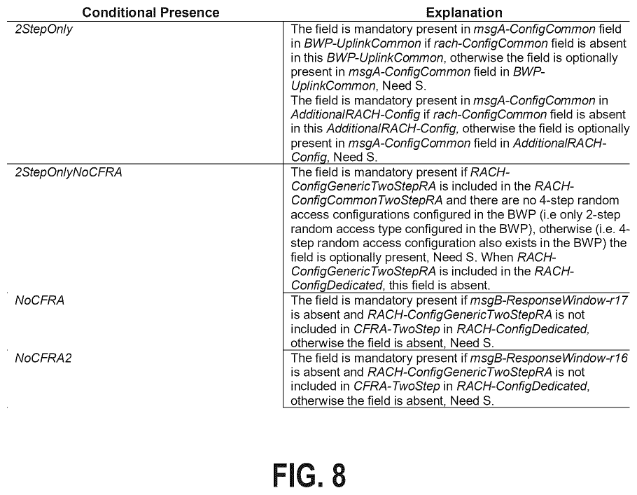

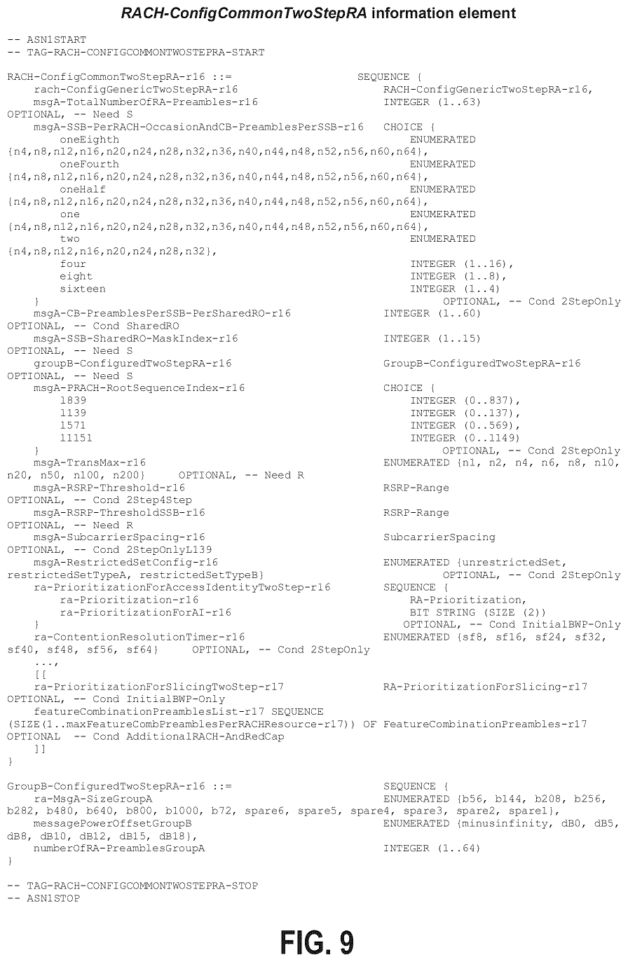

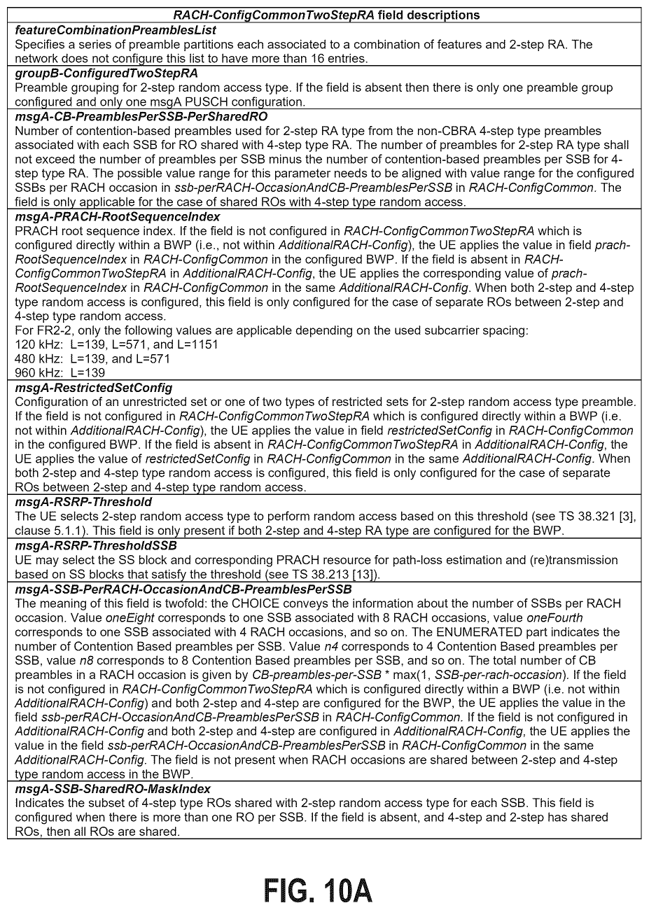

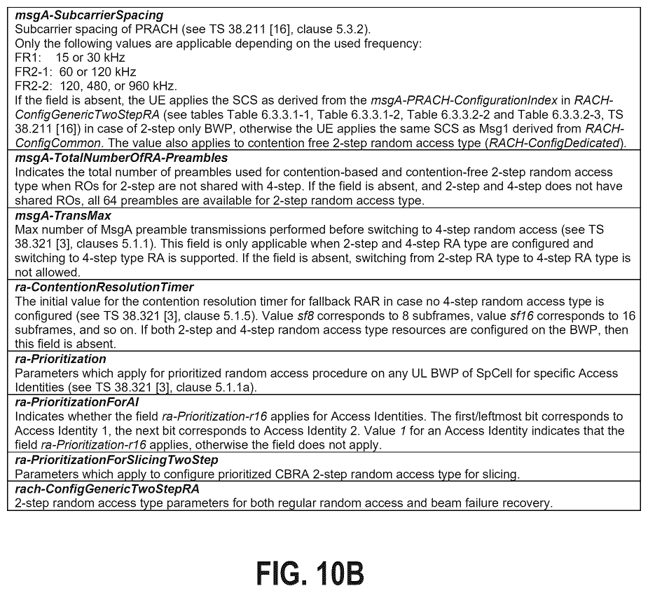

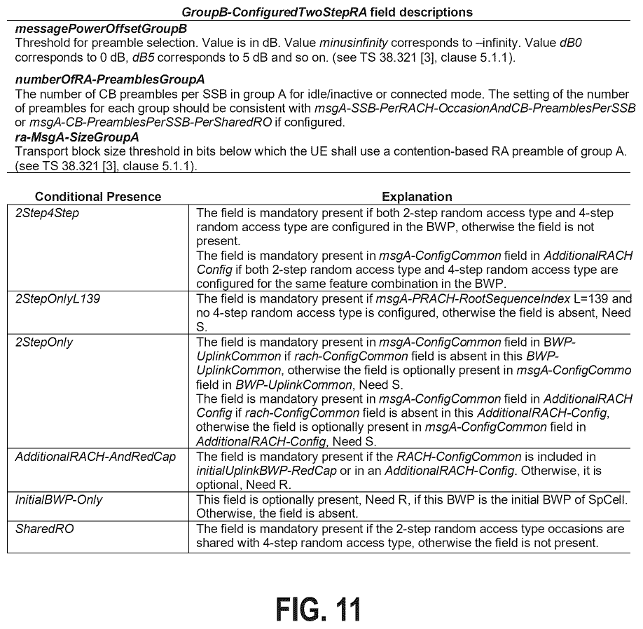

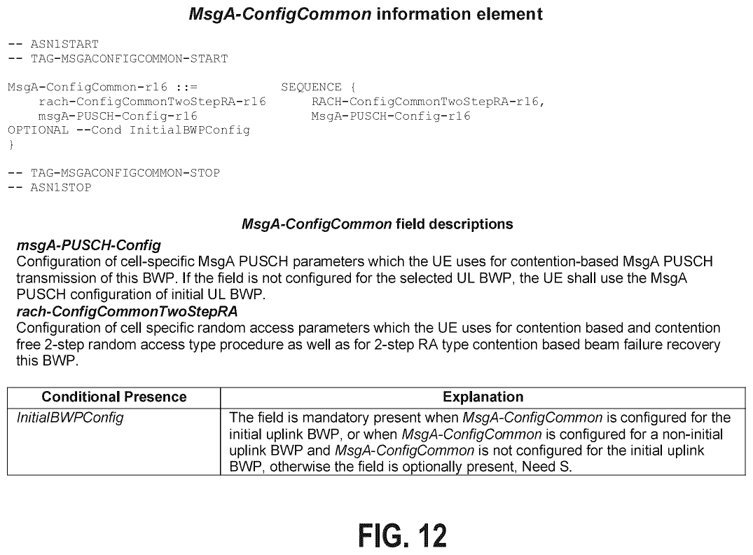

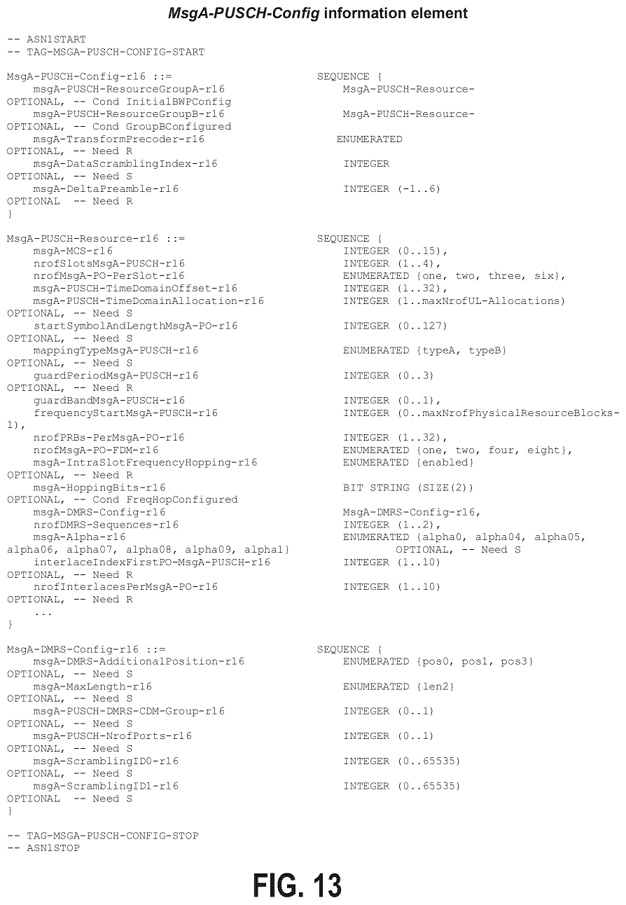

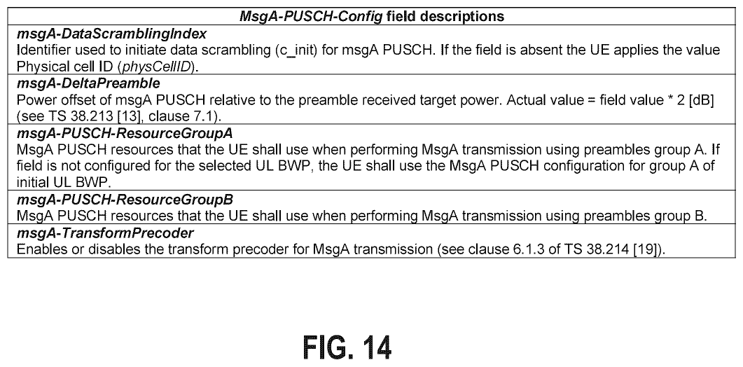

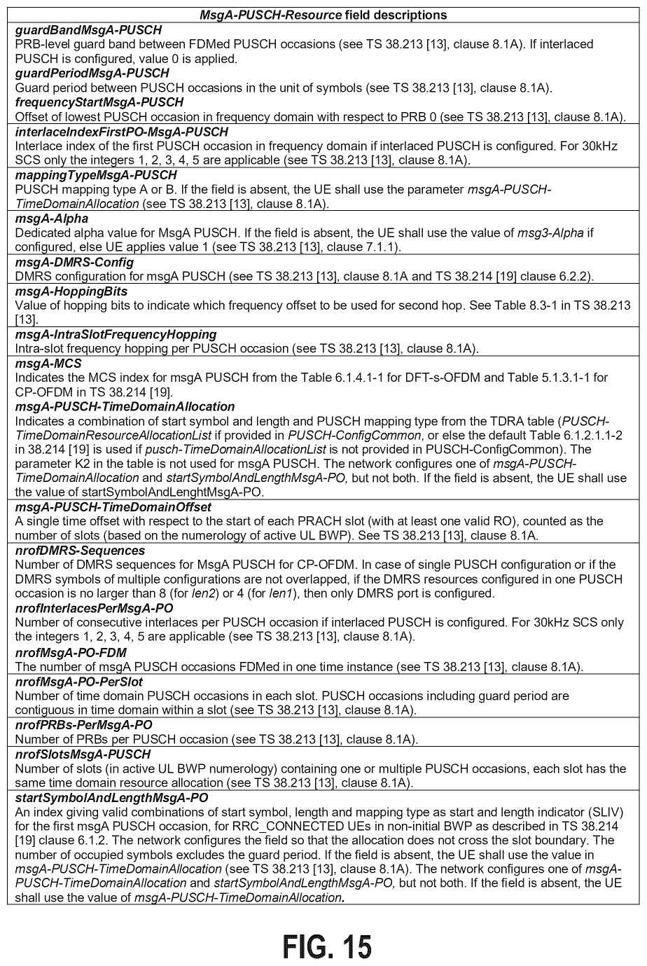

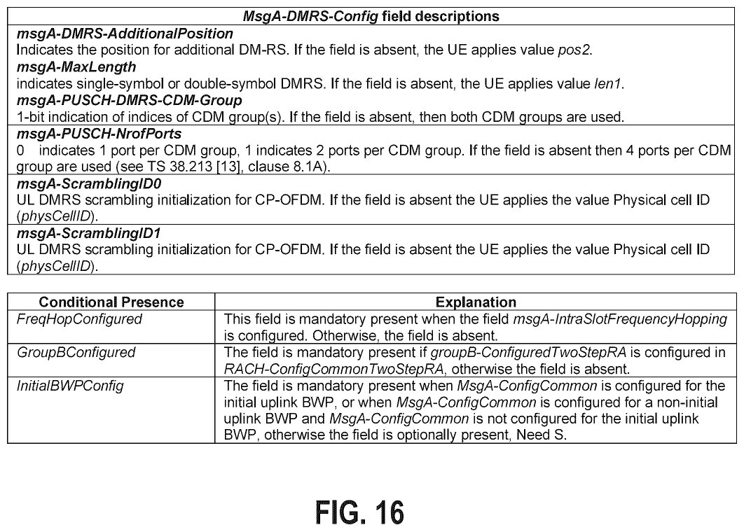

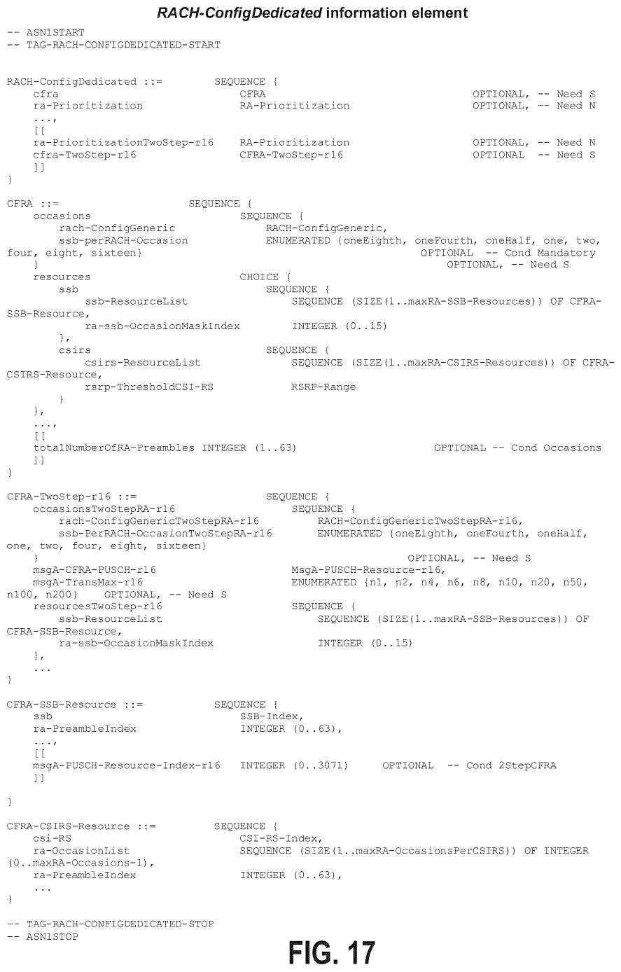

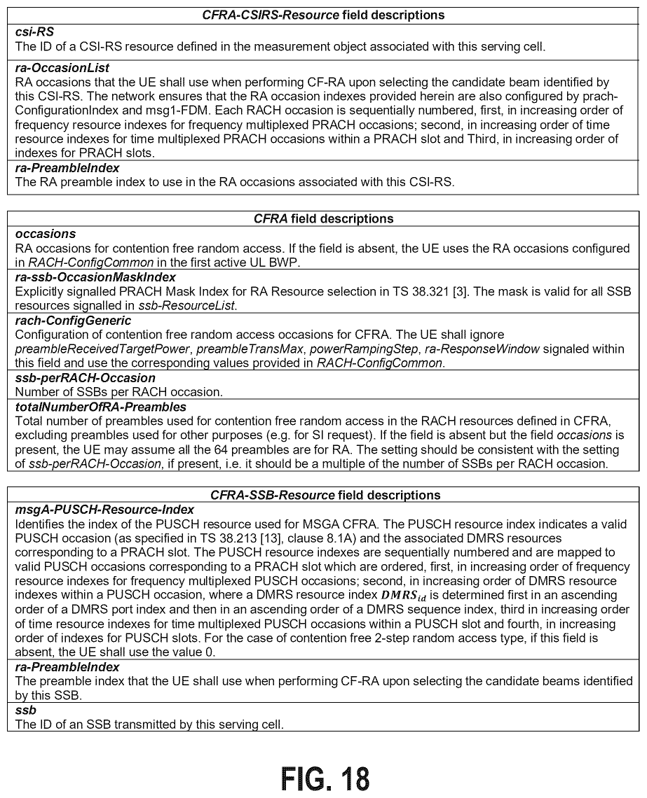

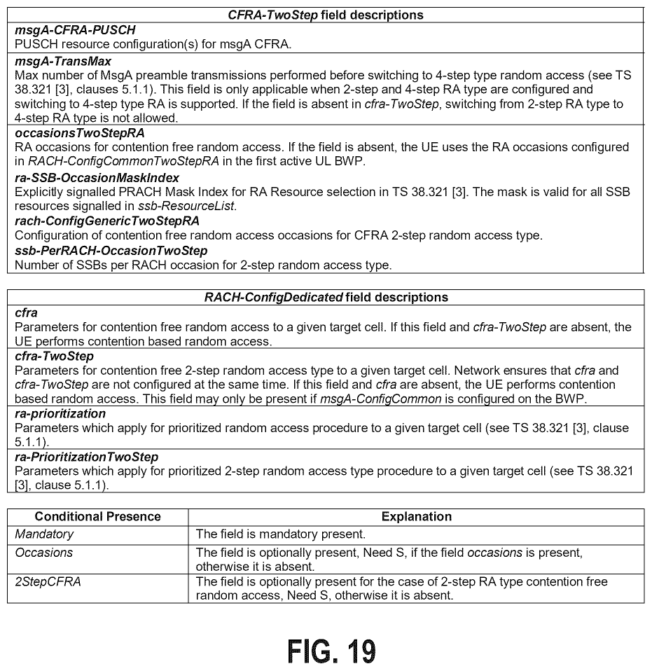

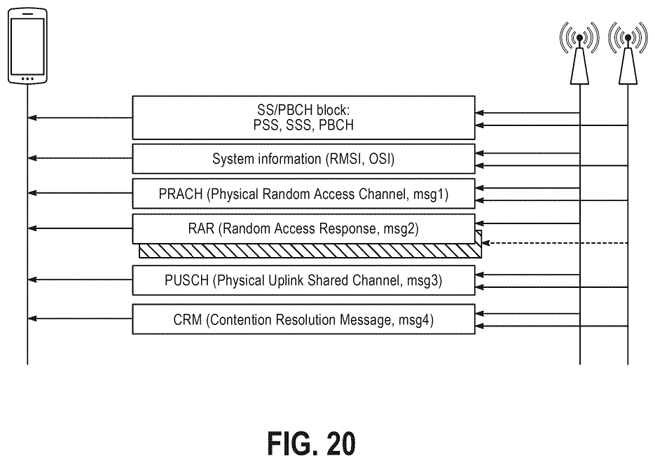

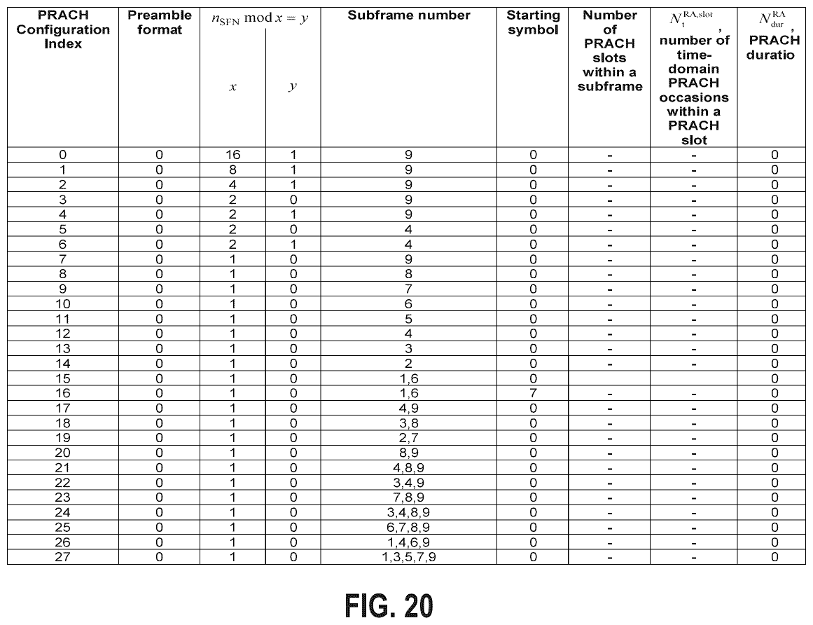

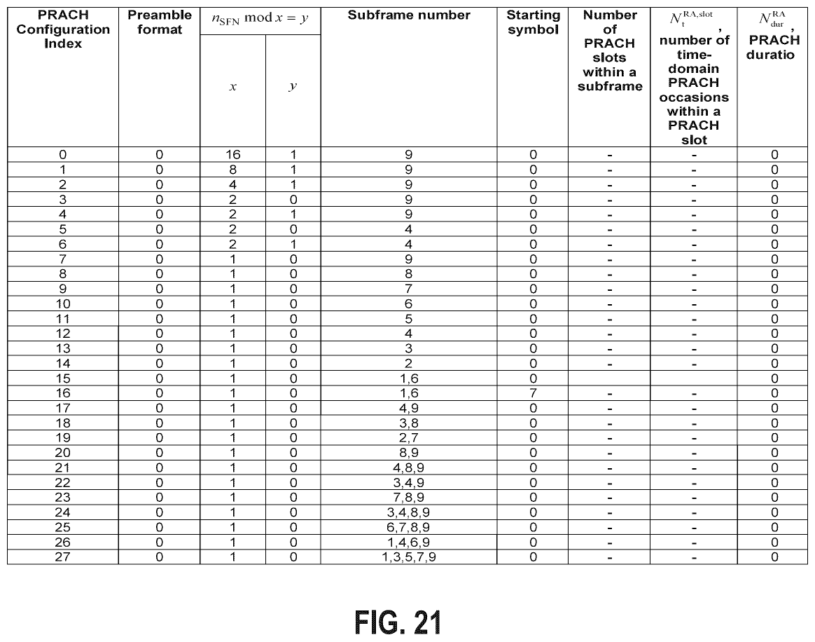

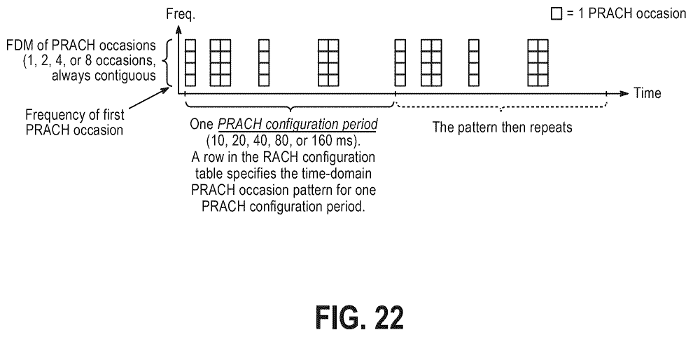

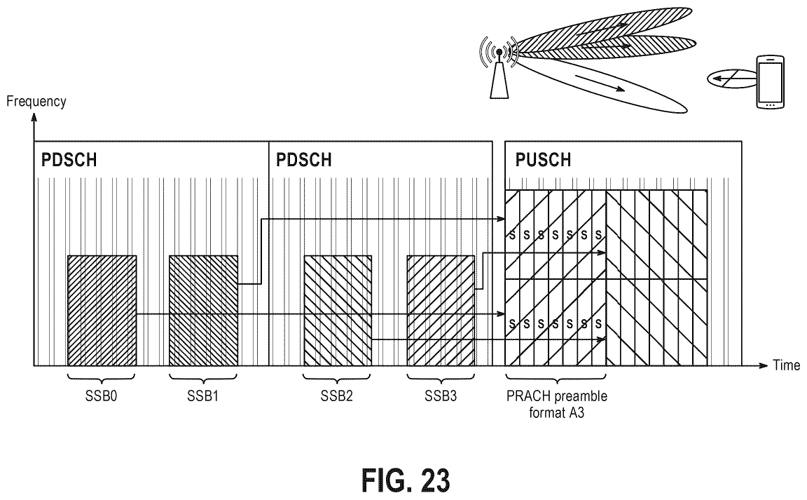

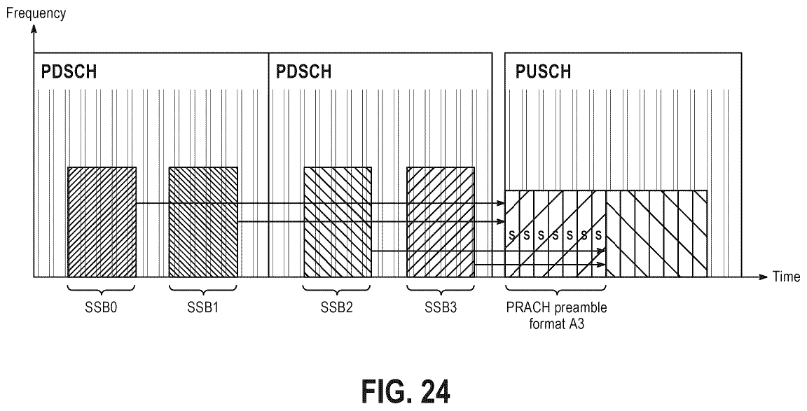

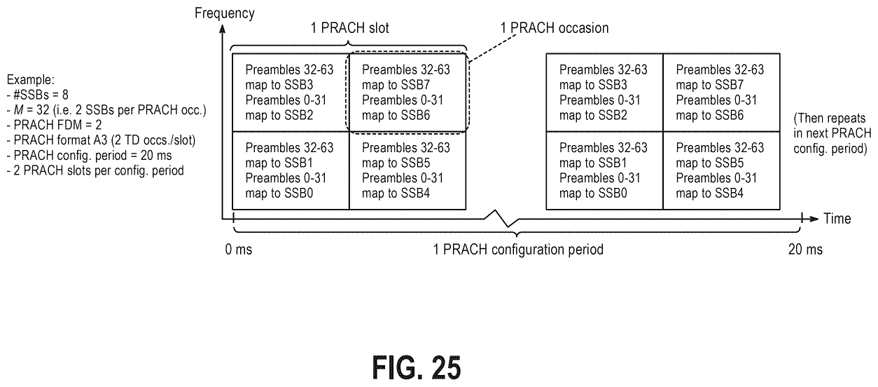

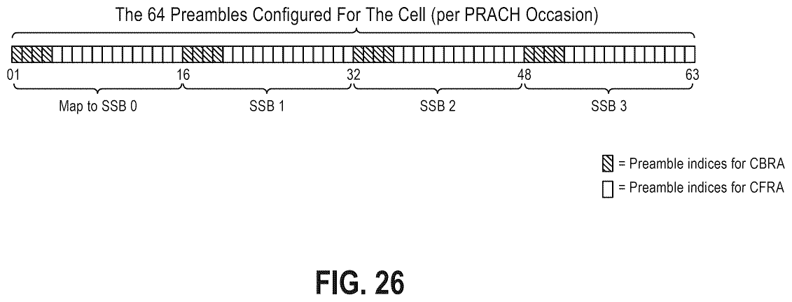

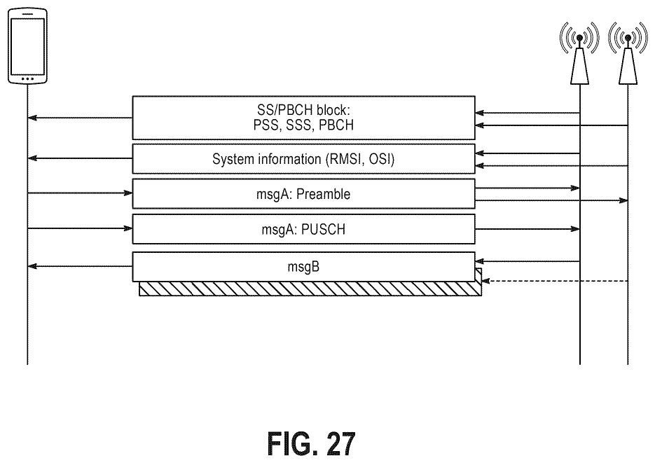

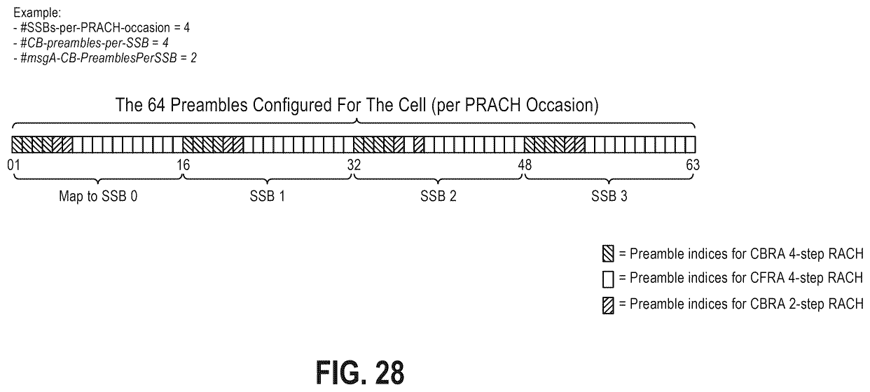

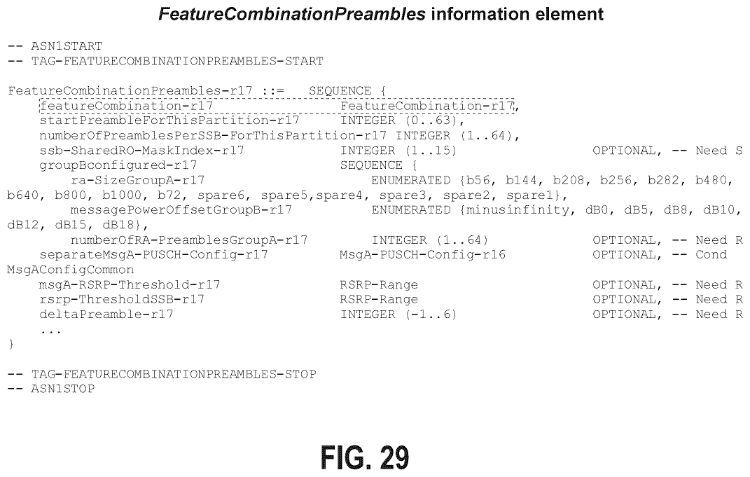

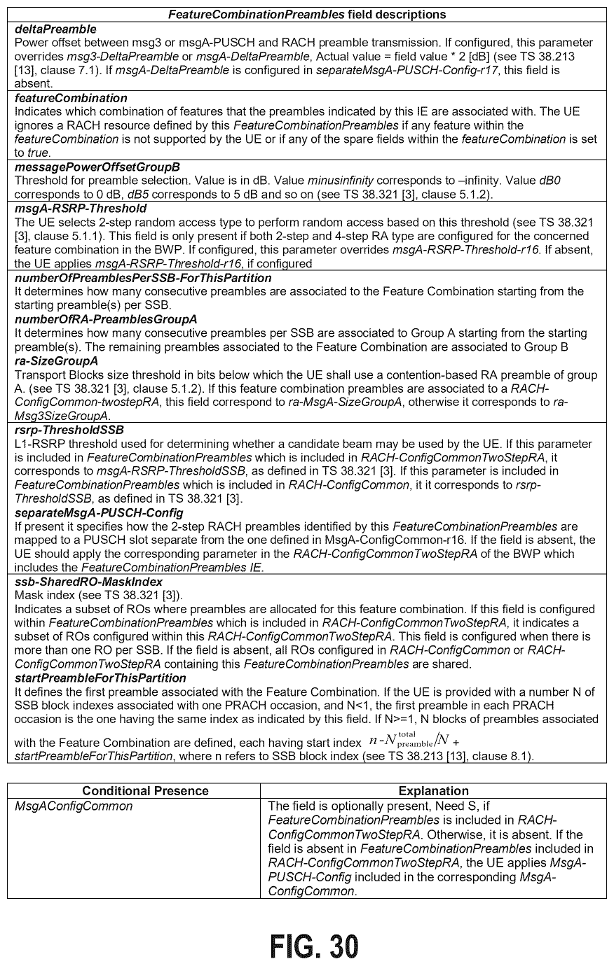

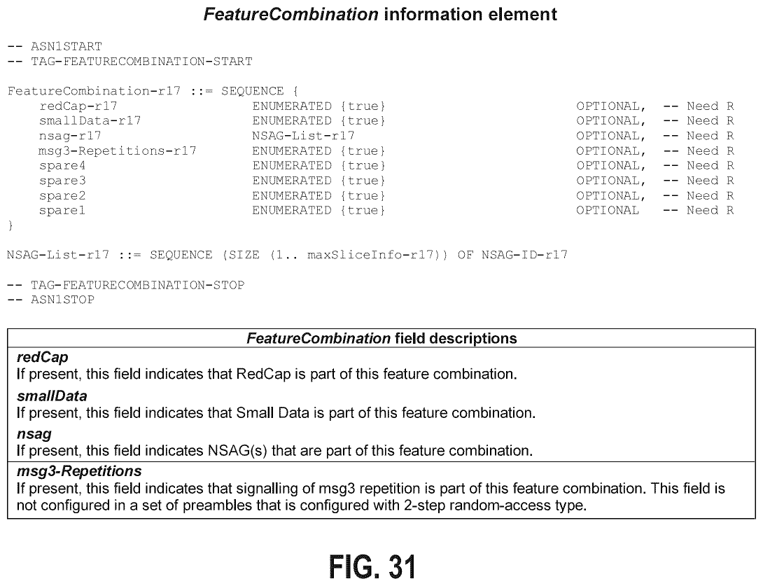

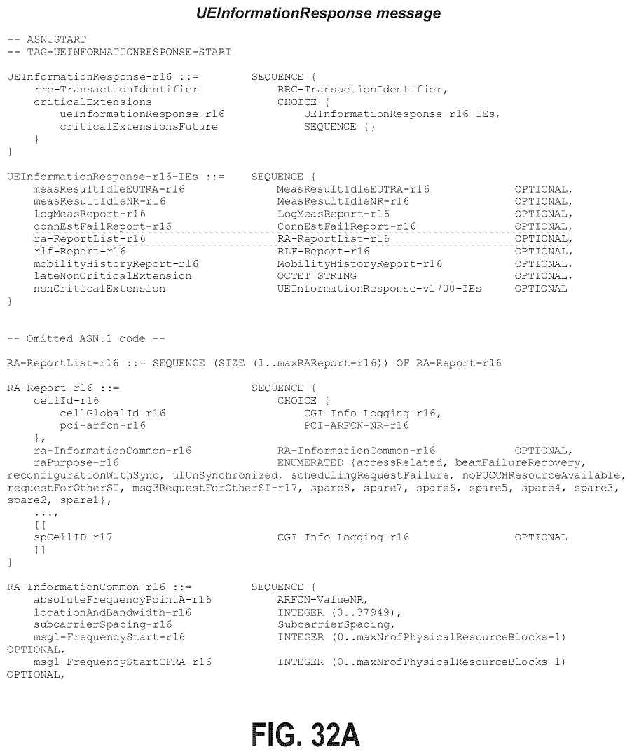

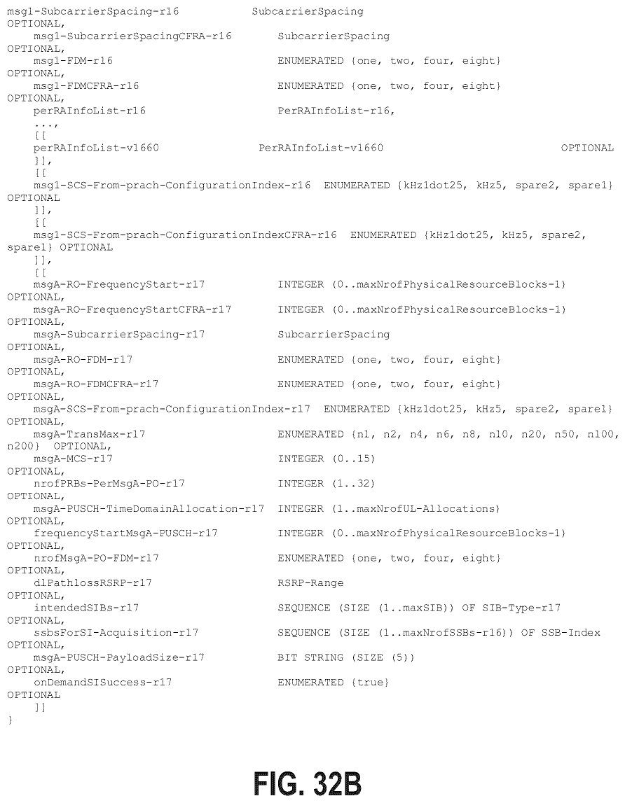

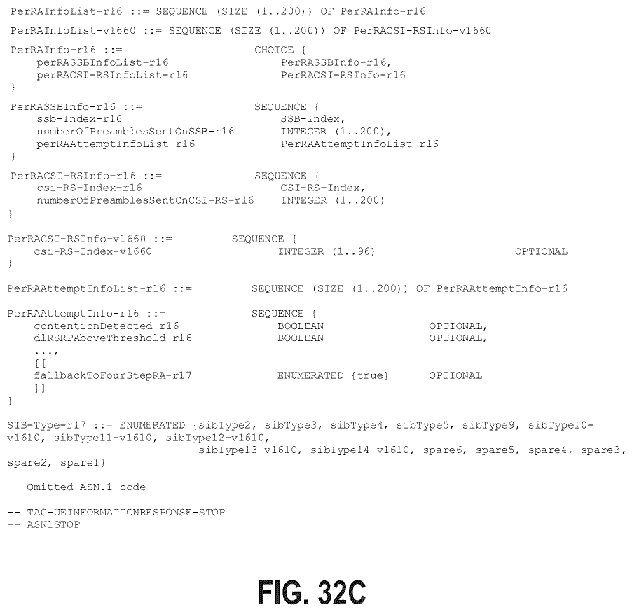

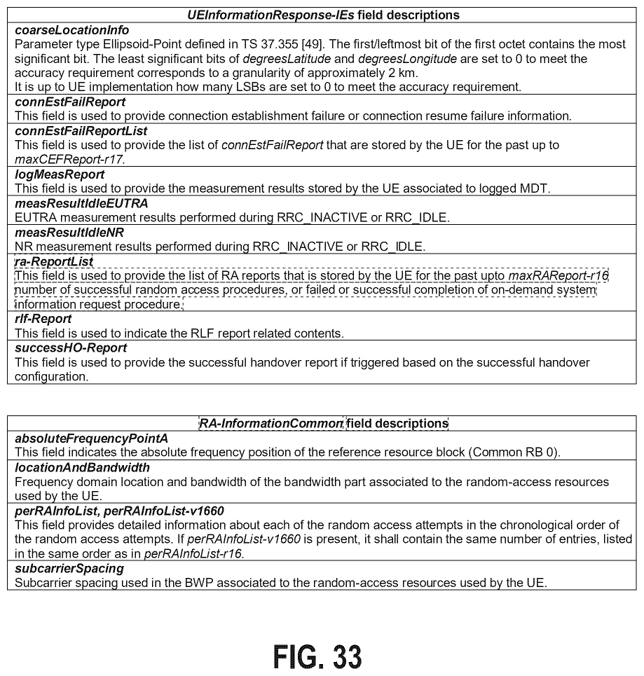

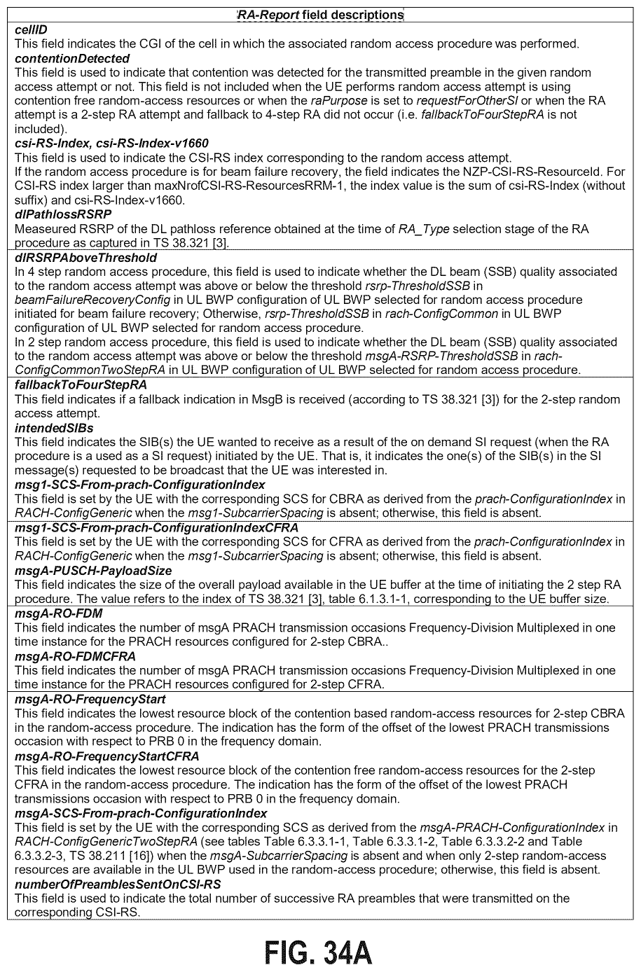

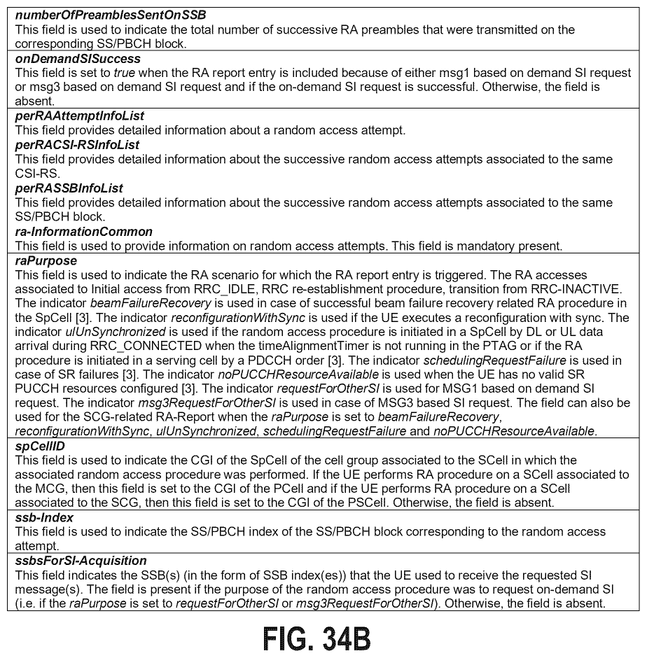

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in the prior art. As mentioned above regarding RA Optimization, to further improve the RA report (e.g., the RA-Report-r16 IE) as a basis for RA configuration optimization, 3GPP has (in the RAN2 #119bis meeting) agreed that a UE that has used a RA preamble from a feature combination RA preamble partition should include, in the corresponding RA report, indications of both the feature combination (which may be one or more features) that triggered the UE to initiate the random access procedure (denoted as the “triggering feature combination”) and the feature combination (which may be one or more features) associated with the RA preamble partition from which the UE selected the RA preamble it used (denoted as the “used feature combination”). An RA-Report-r16 IE can potentially contain a large amount of data, and as new features are introduced in the network, more information is included in the RA-Report-r16 IE (like the above-mentioned feature combination information), meaning that the signaling overhead may become undesirably large.

Certain aspects of the disclosure and their embodiments may provide solutions to these or other challenges. Certain proposed embodiments can address the problems described above by applying, to the new feature combination information agreed to be included in the RA report, a principle where some information can be deduced without explicit inclusion in the RA Report IE.

To this end, one aspect of certain proposed embodiments described herein is to omit one of the triggering feature combinations and the used feature combination information in the RA report when the two feature combinations are identical. Certain embodiments can also include lean ways to capture, in the RA report, cases where the triggering feature combination changes during the course of a random access procedure.

Certain embodiments may provide one or more of the following technical advantages. Certain embodiments enable more information, covering new features, to be included in the RA report in a data-efficient manner. With certain embodiments proposed in this disclosure the amount of the data bits to be logged by the UE will be half of the RA reporting methods that don't utilize the embodiments described herein, in particular when the set of triggering features and the used feature combination are identical.

Some of the embodiments contemplated herein will now be described more fully with reference to the accompanying drawings. Embodiments are provided by way of example to convey the scope of the subject matter to those skilled in the art.

For the purposes of the present disclosure, the terms “random access preamble”, “RA preamble” and “preamble” are used interchangeably. The term “feature combination” as used herein refers to a set of features comprising one or more features. The present disclosure contains certain descriptions in terms of NR and the RA-Report-r16 IE in the 3GPP standard for NR. However, the principles of the described embodiments are equally applicable to LTE (or other RAT or standards), the RACH-Report-r16 IE, or a new version of this IE, e.g., a RACH-Report-r18 IE or a RACH-Report-r19 IE.

A way to address the problems described above is to try to identify ways that some information in the RA-Report-r16 IE could be deduced without inclusion of one or more parameters explicitly providing the information. Modifying the existing content of the RA-Report-r16 IE to achieve this may cause backwards compatibility problems, and hence it is preferable to target new information, which is planned for inclusion in the RA-Report-r16 IE, but for which the inclusion is yet to be specified.

Certain embodiments of the present disclosure can include applying such a principle to the feature combination information agreed to include in the RA-Report-r16 IE in release 18 of the 3GPP standard, e.g., the following two information items:
Feature or combination of features that triggered the RA in the UE—the “triggering feature combination” (applicable if the UE used a RA preamble signaling certain feature support).
Used feature combination—the feature combination associated with the RA preamble partition the UE selected a RA preamble from, e.g., the “used feature combination” (applicable if the UE used a RA preamble signaling certain feature support).

A first observation is that these information items are applicable only if the UE has used a RA preamble from a RA preamble partition that is used for signaling feature combination support (i.e., which is associated with a feature combination). Hence, in order not to unnecessarily increase the size of the RA-Report-r16 IE, both these information items should be optional in the RA-Report-r16 IE.

A second relevant observation in this context is that the combination of features that triggered the RA procedure in the UE may or may not perfectly match (i.e., be identical to) the used feature combination. The two above information items may in some cases be identical and in other cases they may be different. This observation can be leveraged to make the presence in the RA-Report-r16 IE of one of the information items—not only optional based on usage of a RA preamble partition associated with a feature combination—but also dependent on the presence of the other of the two information items. To this end, if the UE selected a RA preamble from a RA preamble partition associated with a feature combination, and one of the two related information items is present in the RA-Report-r16 IE, then, if the other of the two related information items is identical to the one that is present, the other of the two related information items may be omitted in this RA-Report-r16 IE, but if the two information items are not identical, they should both be included in the RA-Report-r16 IE.

For instance, if the triggering feature combination information is present in the RA-Report-r16 IE and the used feature combination information is identical, then the used feature combination information can be omitted and the receiver of the RA-Report-r16 IE (e.g., a gNB) can thereby deduce that the used feature combination is identical to the triggering feature combination. Similarly, as another example, if the used feature combination information is present in the RA-Report-r16 IE and the triggering feature combination information is identical, then the used feature combination information can be omitted and the receiver of the RA-Report-r16 IE (e.g., a gNB) can thereby deduce that the triggering feature combination is identical to the used feature combination.

Note that a UE preferably applies the above method for optional and conditional reporting of the triggering feature combination and/or used feature combination already when it logs the information related to a RA procedure (with the intention to later send it to the network in the form of one or more RA report(s)), e.g. in the UE internal variable VarRA-Report-r16 specified in section 7.4 of 3GPP TS 38.331 version 17.2.0.

The triggering feature combination and used feature combination may be included once in an RA-Report-r16 IE, i.e., once per RA procedure, e.g., in the top level of the RA-Report-r16 IE or in the RA-InformationCommon-r16 IE. Alternatively, the triggering feature combination and used feature combination may be included per RA attempt in an RA-Report-r16 IE, e.g., in the PerRAAttemptInfo-r16 IE. As another alternative, the triggering feature combination and used feature combination may be included in a way that they correspond to a subset of the RA attempts in a RA procedure, e.g. by including them either in the PerRAInfo-r16 IE or in the PerRASSBInfo-r16 IE and the PerRACSI-RSInfo-r16 IE (or, since these three IEs lack preparation for extensions, in new IEs corresponding to these IEs in terms of which RA attempts the information pertains to).

Since the typical case can be assumed to be that the triggering feature combination remains the same (and the used feature combination consequently also remains the same) across all the RA attempts during an RA procedure, the most data-efficient alternative is to include the triggering feature combination and the used feature combination only once per RA procedure, i.e., only once per RA-Report-r16 IE. However, even if this is fine for the typical case, it will mean that information is lost in the non-typical case where the triggering feature combination (and thus potentially also the used feature combination) changes during the course of a RA procedure. Therefore, inclusion of the triggering feature combination and the used feature combination per RA attempt, i.e., in the PerRAAttemptInfo-r16 IE, in the RA-Report-r16 IE also has its merits.

But note that irrespective of where, and how many times the feature combination is included in a RA report, certain proposed methods to include only one of the triggering feature combinations and the used feature combination (in each pair of triggering feature combination and used feature combination) if they are identical applies.

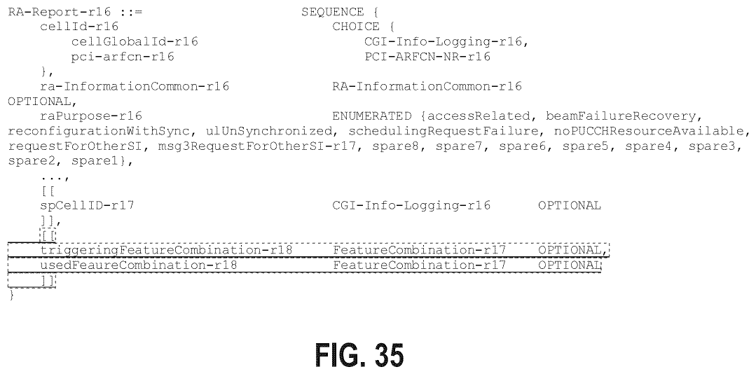

Inclusion of feature combination information at the top level of the RA-Report-r16 IE may for example be realized as shown in the highlighted language in FIG. 35 based on ASN.1 code in 3GPP TS 38.331 version 17.2.0.

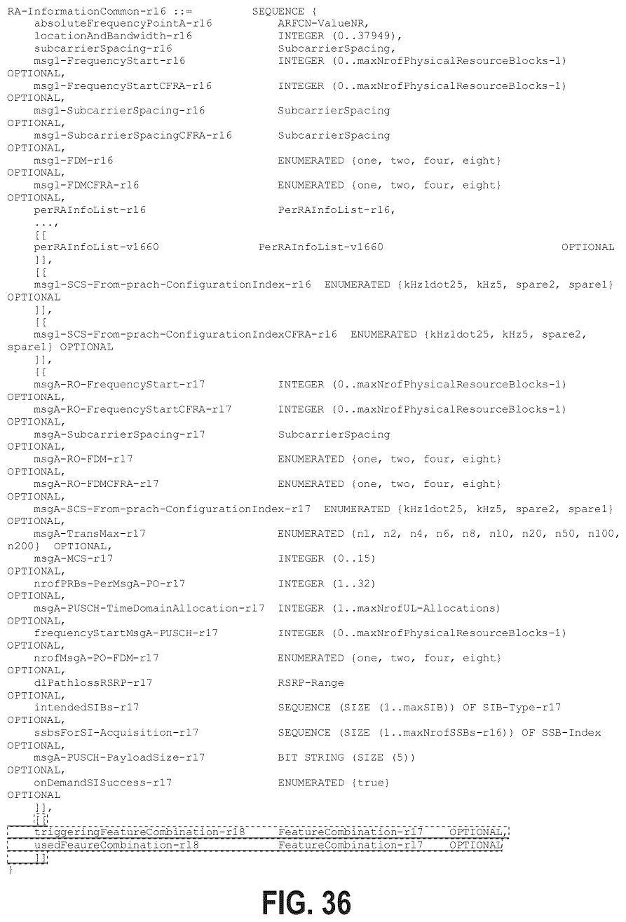

Inclusion of feature combination information in the RA-InformationCommon-r16 IE may for example be realized as shown in the highlighted language in FIG. 36 based on ASN.1 code in 3GPP TS 38.331 version 17.2.0.

A non-limiting example implementation of a proposed method in the procedural text of the TS 38.331 version 17.1.0 is shown highlighted and underlined in the following excerpt:

RA information determination for RA report and RLF report

```
The UE shall set the content in ra-InformationCommon as follows:
  1> set the absoluteFrequencyPointA to indicate the absolute frequency of the reference resource block
    associated to the random-access resources used in the random-access procedure;
  1> set the locationAndBandwidth and subcarrierSpacing associated to the UL BWP of the random-access
    resources used in the random-access procedure;
  1> if contention based random-access resources are used in the random-access procedure:
    2> set the msgA_RO-FrequencyStart and msgA-RO-FDM and msgA-SubcarrierSpacing associated to the 2
      step random-access resources if used in the random-access procedure;
    2> if msgA-SubcarrierSpacing associated to the 2 step random-access resources used in the random-access
      procedure is available:
      3> set the msgA-SubcarrierSpacing associated to the 2 step random-access resources used in the random-
        access procedure;
    2> else if only 2 step random-access resources are available in the UL BWP used in the random-access
      procedure:
      3> set the msgA-SCS-From-prach-ConfigurationIndex to the subcarrier spacing as derived from the
        msgA-PRACH-ConfigurationIndex used in the 2-step random-access procedure;
    2> else:
      3> set the msg1-SubcarrierSpacing associated to the 4 step random-access resources used in the random-
        access procedure;
    2> set the msg1-FrequencyStart associated to the 4 step random-access resources if used in the random-
      access procedure, and if its value is different from the value of msgA-RO-FrequencyStart if it is included
      in the ra-InformationCommon;
    2> set the msg1-FDM associated to the 4 step random-access resources if used in the random-access
      procedure, and if its value is different from the value of msgA-RO-FDMCFRA if it is included in the ra-
      InformationCommon;
    2> if msg1-SubcarrierSpacing associated to the 4 step random-access resources used in the random-access
      procedure is available, and if its value is different from the value of msgA-SubcarrierSpacing if it is
      included in the ra-InformationCommon:
      3> set the msg1-SubcarrierSpacing associated to the 4 step random-access resources used in the random-
        access procedure;
    2> else:
      3> set the msg1-SCS-From-prach-ConfigurationIndex to the subcarrier spacing as derived from the
        prach-ConfigurationIndex used in the 4-step random-access procedure, and if its value is different
        from the value of msgA-SCS-From-prach-ConfigurationIndex if it is included in the ra-
        InformationCommon;
  1> if contention free random-access resources are used in the random-access procedure:
    2> set the msg1-FrequencyStartCFRA and msg1-FDMCFRA associated to the 4 step random-access
      resources if used in the random-access procedure;
    2> if msg1-SubcarrierSpacing associated to the 4 step random-access resources used in the random-access
      procedure is available:
      3> set the msg1-SubcarrierSpacingCFRA associated to the 4 step random-access resources used in the
        random-access procedure;
    2> else:
      3> set the msg1-SCS-From-prach-ConfigurationIndexCFRA to the subcarrier spacing as derived from the
        prach-ConfigurationIndex used in the 4 step random-access procedure;
    2> set the msgA-RO-FrequencyStartCFRA and msgA-RO-FDMCFRA associated to the 2 step contention free
      random access resources if used in the random-access procedure;
    2> set the msgA-MCS, the nrofPRBs-PerMsgA-PO, the msgA-PUSCH-TimeDomainAllocation, the
      frequencyStartMsgA-PUSCH, the nrofMsgA-PO-FDM associated to the 2 step random-access resources if
      used in the random-access procedure;
    2> if msgA-SubcarrierSpacing associated to the 2 step random-access resources used in the random-access
      procedure is available:
      3> set the msgA-SubcarrierSpacing associated to the 2 step random-access resources used in the random-
        access procedure;
    2> else if only 2 step random-access resources are available in the UL BWP used in the random-access
      procedure:
      3> set the msgA-SCS-From-prach-ConfigurationIndex to the subcarrier spacing as derived from the
        msgA-PRACH-ConfigurationIndex used in the 2-step random-access procedure;
    2> else:
      3> set the msg1-SubcarrierSpacing associated to the 4 step random-access resources used in the random-
        access procedure;
  1> if the random access procedure is initialized with RA_TYPE set to 2-stepRA as described in TS 38.321 [3]:
    2> set the dlPathlossRSRP to the measeured RSRP of the DL pathloss reference obtained at the time of
      RA_Type selection stage of the initialization of the RA procedure as captured in TS 38.321 [3];
    2> if the configuration for the random access msgA-TransMax was configured in RACH-ConfigDedicated for
      this random access procedure, and ra-Purpose is set to reconfigurationWithSync:
      3> set msgA-TransMax to the value of msgA-TransMax in RACH-ConfigDedicated;
    2> else if msgA-TransMax was configured in RACH-ConfigCommonTwoStepRA:
      3> set msgA-TransMax to the value of msgA-TransMax in RACH-ConfigCommonTwoStepRA;
    2> set the msgA-PUSCH-PayloadSize to the size of the overall payload available in the UE buffer at the time
      of initiating the 2 step RA procedure;
  1> if the purpose of the random access procedure is to request on-demand system information (i.e., if the
    raPurpose is set to requestForOtherSI or msg3RequestForOtherSI):
    2> set the intendedSIBs to indicate the SIB(s) the UE wanted to receive as a result of the SI request;
    2> set the ssbsForSI-Acquisition to indicate the SSB(s) used to receive the SI message;
    2> if the on-demand system information acquisition was successful:
      3> set the onDemandSISuccess to true;
  1> set the parameters associated to individual random-access attempt in the chronological order of attempts in
    the perRAInfoList as follows:
    2> if the random-access resource used is associated to a SS/PBCH block, set the associated random-access
      parameters for the successive random-access attempts associated to the same SS/PBCH block for one or
      more random-access attempts as follows:
      3> set the ssb-Index to include the SS/PBCH block index associated to the used random-access resource;
      3> set the numberOfPreamblesSentOnSSB to indicate the number of successive random-access attempts
        associated to the SS/PBCH block;
      3> for each random-access attempt performed on the random-access resource, include the following
        parameters in the chronological order of the random-access attempt:
        4> if the random-access attempt is performed on the contention based random-access resource and if
          raPurpose is not equal to ‘requestForOtherSI’, include contentionDetected as follows:
          5> if contention resolution was not successful as specified in TS 38.321 [6] for the transmitted
            preamble:
            6> set the contentionDetected to true;
          5> else:
            6> set the contentionDetected to false;
        4> if the random access attempt is a 2-step random access attempt:
          5> if fallback from 2-step random access to 4-step random access occurred during the random
            access attempt:
            6> set fallbackToFourStepRA to true;
        4> if the random-access attempt is performed on the contention based random-access resource; or
        4> if the random-access attempt is performed on the contention free random-access resource and if the
          random-access procedure was initiated due to the PDCCH ordering:
          5> if the random access attempt is a 4-step random access attempt and the SS/PBCH block RSRP
            of the SS/PBCH block corresponding to the random-access resource used in the random-access
            attempt is above rsrp-ThresholdSSB; or
          5> if the random access attempt is a 2-step random access attempt and the SS/PBCH block RSRP
            of the SS/PBCH block corresponding to the random-access resource used in the random-access
            attempt is above msgA-RSRP-ThresholdSSB:
            6> set the dIRSRPAboveThreshold to true;
          5> else:
            6> set the dIRSRPAboveThreshold to false;
    2> else if the random-access resource used is associated to a CSI-RS, set the associated random-access
      parameters for the successive random-access attempts associated to the same CSI-RS for one or more
      random-access attempts as follows:
      3> set the csi-RS-Index to include the CSI-RS index associated to the used random-access resource;
      3> set the numberOfPreamblesSentOnCSI-RS to indicate the number of successive random-access
        attempts associated to the CSI-RS.
  1> if the random access procedure is triggered for a set of features:
    2> include triggeringFeatureCombination in the RA report;
  1> if the UE selected/used a different combination of features than the triggeringFeatureCombination to select
    the random access resources for this random access procedure: or
  1> if triggeringFeatureCombination and the used combination of features (usedFeatureCombination) are not
    identical:
    2> include usedFeatureCombination in the RA report;
  NOTE 1: Void.
```

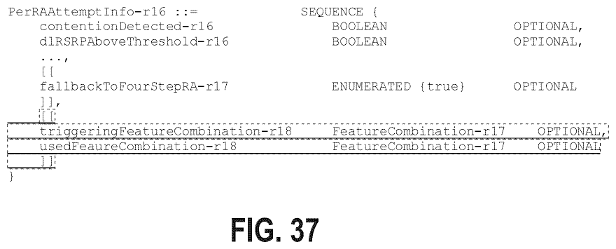

Inclusion of feature combination information in the PerRAAttemptInfo-r16 IE may for example be realized as shown in the highlighted language in FIG. 37 based on ASN.1 code in 3GPP TS 38.331 version 17.2.0.

In a separate embodiment, the conditional inclusion RA related information is not limited to the feature combination RA information. The RA related information of new introduced features in later releases can conditionally be included in the RA report as well.

In certain embodiments, the conditional feature related RA information can be requested via an indication by the network in a RRC message e.g., UEInformationRequest message independently. Upon reception of this indication, the UE includes only the RA related information associated to the requested feature. In other words, the UE reports only a part of RA related information upon the network request, the information that the network is interested in collecting data of at this moment. For instance, the UE includes the RA related information associated to a specific feature upon explicit indication by the network.

### Triggering Feature Combination Changes

Certain embodiments can include the triggering feature combination changing during a series of RA attempts. If the set of features that triggered the RA procedure is changed during the course of an RA procedure, e.g., between two RA attempts, it may be beneficial that this is captured in the RA report. For this, proposed embodiments can comprise several alternatives which are described below. In these descriptions, the term “feature combination information” refers to both the triggering feature combination and the used feature combination (but where one of them may be omitted if they are identical).

### Indication of Feature Combination Changes on the RA Attempt Level

In certain embodiments, the feature combination information (i.e., the triggering feature combination and the used feature combination information, where one of them may be omitted if they are identical) is indicated at the per RA attempt level in the RA-Report-r16 IE, e.g., in the PerRAAttemptInfo-r16 IE. But if the feature combination information is unchanged since the preceding RA attempt, it is omitted in the PerRAAttemptInfo-r16 IE corresponding to the subsequent RA attempt. Hence, the feature combination information is included in the PerRAAttemptInfo-r16 IE representing the first RA attempt in a RA procedure, and then included in any further PerRAAttemptInfo-r16 IE in the same RA procedure (i.e., in the same RA-Report-r16 IE) only if the feature combination information is changed for the RA attempt the PerRAAttemptInfo-r16 IE represents.

### Indication of Initial Feature Combination Information at the RA Procedure Level in the RA Report and Indication of Changes at the RA Attempt Level

In certain embodiments, the initial feature combination information is indicated at the top level in the RA-Report-r16 IE or in the RA-InformationCommon-r16 IE. Then, any subsequent change of the feature combination information in a subsequent RA attempt is indicated in the PerRAAttemptInfo-r16 IE representing the RA attempt where the change occurred.

### Conditional Indication of Feature Combination Information Changes

In other embodiments, a change in the feature combination information is indicated only if both the triggering feature combination and the used feature combination are changed, e.g., if a change in the triggering feature combination results in a change of the used feature combination. As in the previous two examples, the initial feature combination information is indicated at the top level of the RA-Report-r16 IE or in the RA-InformationCommon-r16 IE or in the first PerRAAttemptInfo-r16 IE, and then a changed feature combination information is included in a subsequent PerRAAttemptInfo-r16 IE only if the changed triggering feature combination resulted in a change of the used feature combination (i.e. only if both the triggering feature combination and the used feature combination are changed).

### Indication of Only the Initial Feature Combination Information

In other embodiments, any changes in the feature combination information during a RA procedure are ignored in the RA report. Only the initial feature combination information is reported. The motivation for this alternative is that the case where the feature combination changes between two RA attempts in a RA procedure may be regarded as a corner case that is too rare to motivate the increased specification complexity (and slightly increased signaling overhead). The initial feature combination information may be included at the top level of the RA-Report-r16 IE or in the RA-InformationCommon-r16 IE. Of these two, inclusion in the RA-InformationCommon-r16 IE has the advantage that the information will automatically be included also in an RLF report, i.e., in an RLF-Report-r16 IE, when a random access procedure is involved in the RLF, e.g. when the RLF cause is random access failure, i.e. when the rlf-Cause-r16 IE is set to “randomAccessProblem”.

### Indication of Only the Last Feature Combination Information

In other alternative embodiments, any changes in the feature combination information during a RA procedure are ignored in the RA report. Only the last feature combination information is reported. As in the alternative where only the initial feature combination is reported, as described in the previous example, the motivation for this alternative is that the case where the feature combination changes between two RA attempts in a RA procedure may be regarded as a corner case that is too rare to motivate the increased specification complexity (and slightly increased signaling overhead). The last feature combination information may be included at the top level of the RA-Report-r16 IE or in the RA-InformationCommon-r16 IE. As in the alternative where only the initial feature combination is reported, as described in the previous example, ff these two, inclusion in the RA-InformationCommon-r16 IE has the advantage that the information will automatically be included also in an RLF report, i.e. in an RLF-Report-r16 IE, when a random access procedure is involved in the RLF, e.g. when the RLF cause is random access failure, i.e. when the rlf-Cause-r16 IE is set to “randomAccessProblem”.

Note that in the typical case, i.e., when the feature combination information remains the same during the RA procedure, the last feature combination information is the same as the initial feature combination information.

### Additional Embodiments

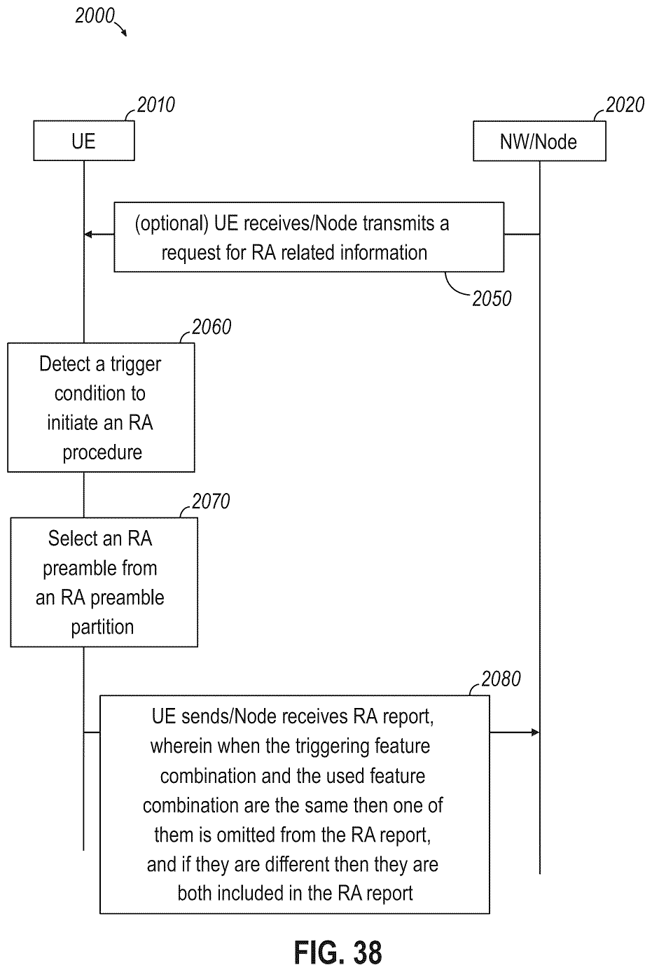

A possible method embodiment under the present disclosure is shown in FIG. 38. Method 2000 comprises a method performed by a UE 2010, network 2020, or network node 2020 for optimizing RA configuration. Step 2050 (optional) is the UE receiving (or network/node transmitting) a request for RA related information. Step 2060 is the UE detecting a trigger condition to initiate an RA procedure. The trigger condition can be based on a triggering feature combination comprising a first one or more features. Step 2070 is the UE selecting an RA preamble from an RA preamble partition. The RA preamble partition can be associated with a used feature combination comprising a second one or more features. Step 2080 is the UE transmitting (or network/node receiving) a RA report, wherein when the triggering feature combination and the used feature combination are the same then one of them is omitted from the RA report, and if the triggering feature combination and the used feature combination are different then they are both included in the RA report. Method 2000 can comprise multiple variations and embodiments and/or additional and/or alternative steps, including the variations discussed above and below.

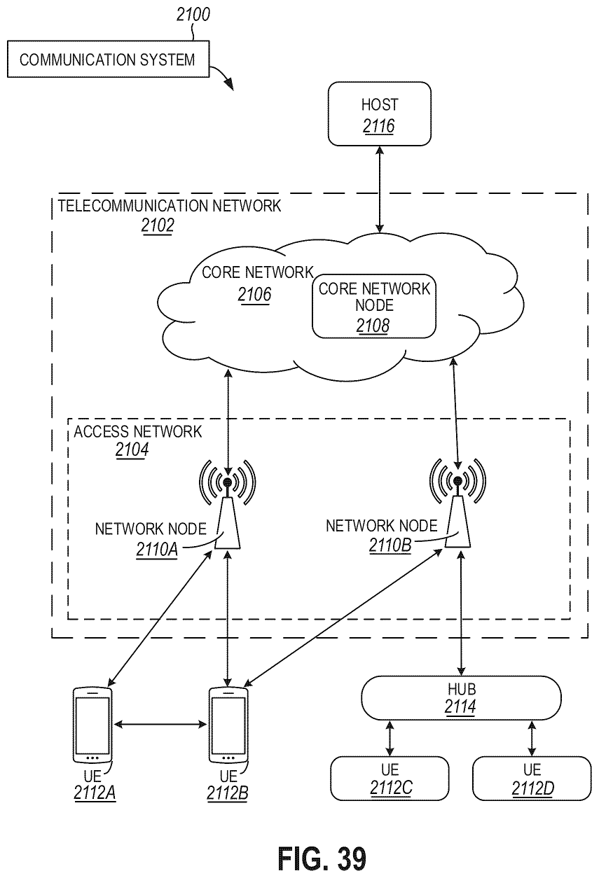

FIG. 39 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 39 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

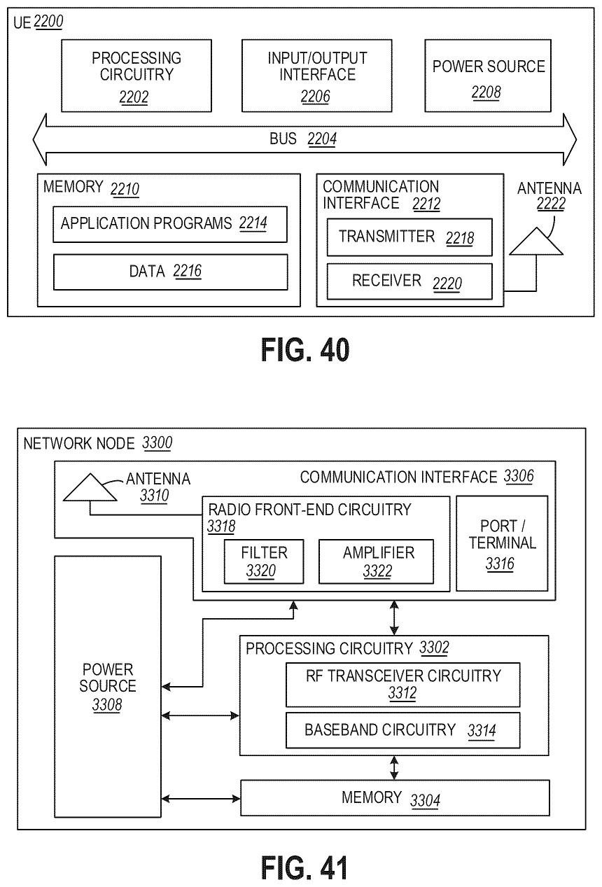

FIG. 40 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 40. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 40.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 41 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 41 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

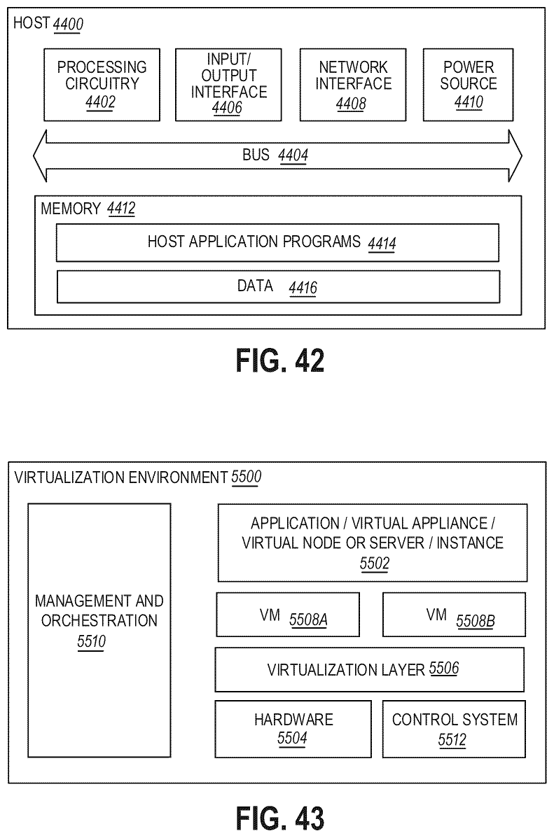

FIG. 42 is a block diagram of a host 4400, which may be an embodiment of the host 2116 of FIG. 39, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 40 and 41, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 43 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

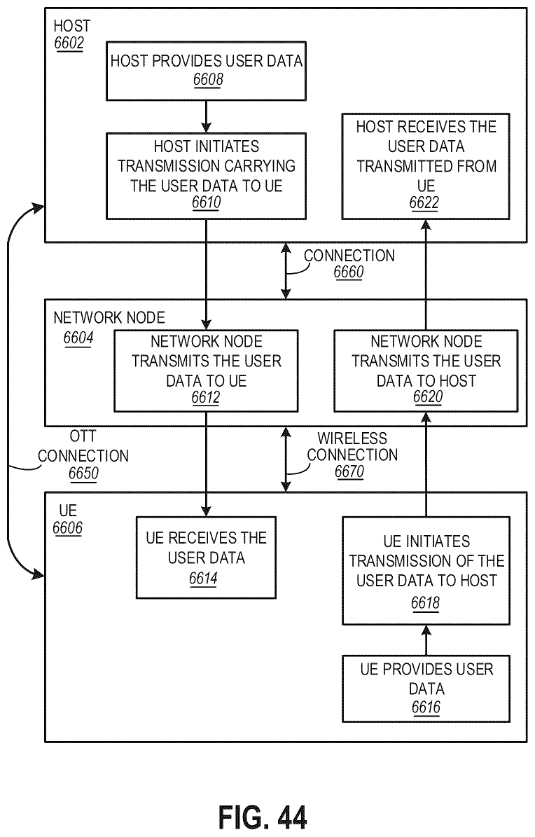

FIG. 44 shows a communication diagram of a host 6602 communicating via a network node 6604 with a UE 6606 over a partially wireless connection in accordance with some embodiments. Example implementations, in accordance with various embodiments, of the UE (such as a UE 2112a of FIG. 39 and/or UE 2200 of FIG. 40), network node (such as network node 2110a of FIG. 39 and/or network node 3300 of FIG. 41), and host (such as host 2116 of FIG. 39 and/or host 4400 of FIG. 42) discussed in the preceding paragraphs will now be described with reference to FIG. 44.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 39) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650.

The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc.; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages-so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### ABBREVIATIONS AND DEFINED TERMS

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method performed by a user equipment, UE, for optimizing random access, RA, configuration, the method comprising:
detecting a trigger condition to initiate an RA procedure, the trigger condition based on a triggering feature combination comprising a first one or more features;
selecting an RA preamble from an RA preamble partition, the RA preamble partition associated with a used feature combination comprising a second one or more features; and
transmitting a RA report to a network node, wherein when the triggering feature combination and the used feature combination are the same then one of them is omitted from the RA report, and if the triggering feature combination and the used feature combination are different then they are both included in the RA report.

2.-3. (canceled)

4. The method of claim 1, wherein the triggering feature combination and/or used feature combination is included in one of the following ways: once in an RA-Report-r16 Information Element, IE; once per RA procedure; in a top level of the RA-Report-r16 IE or in the RA-InformationCommon-r16 IE; per RA attempt in an RA-Report-r16 IE; in the PerRAAttemptInfo-r16 IE.

5. The method of claim 1, wherein the triggering feature combination changes during a plurality of RA attempts.

6. The method of claim 1, wherein the triggering feature combination and/or used feature combination is included at a per-RA attempt level in a RA-Report-r16 Information Element, IE, and;
if the triggering feature combination and used feature combination are unchanged since the preceding RA attempt, it is omitted in a PerRAAttemptInfo-r16 IE corresponding to a subsequent RA attempt; and
if the triggering feature combination and/or used feature combination are changed for a RA attempt then the triggering feature combination and/or used feature combination are included in the PerRAAttemptInfo-r16 IE representing the first RA attempt in a RA procedure, and then included in any subsequent PerRAAttemptInfo-r16 IE in the same RA procedure.

7. The method of claim 1, wherein the triggering feature combination and/or used feature combination is included in at least one of: a RA-Report-r16 Information Element, IE; or a RA-InformationCommon-r16 IE; and wherein any subsequent change of the triggering feature combination and/or used feature combination in a subsequent RA attempt is indicated in a PerRAAttemptInfo-r16 IE representing the RA attempt where the subsequent change occurred.

8.-9. (canceled)

10. The method of claim 1, wherein the triggering feature combination and/or used feature combination is indicated in at least one of: a RA-Report-r16 Information Element, IE; a RA-InformationCommon-r16 IE; a first PerRAAttemptInfo-r16 IE; and
a changed triggering feature combination and/or used feature combination is included in a subsequent PerRAAttemptInfo-r16 IE only if the changed triggering feature combination resulted in a change of the used feature combination.

11. The method of claim 1, wherein any changes in the triggering feature combination and/or used feature combination during a RA procedure are ignored in a subsequent RA report and only the initial triggering feature combination and/or used feature combination is reported in the RA report.

12. (canceled)

13. The method of claim 1, wherein any changes in the triggering feature combination and/or used feature combination during a RA procedure are ignored in the RA report and only a final triggering feature combination and/or used feature combination is reported in a subsequent RA report.

14.-15. (canceled)

16. The method of claim 1, further comprising receiving, from a network, a request for RA related information.

17.-18. (canceled)

19. A method performed by a network node for optimizing random access, RA, configuration, the method comprising:
receiving an RA report from a user equipment, UE, upon the occurrence of a trigger condition, wherein the trigger condition is based on a triggering feature combination comprising a first one or more features and wherein the RA report comprises a RA preamble partition associated with a used feature combination comprising a second one or more features, wherein when the triggering feature combination and the used feature combination are the same then one of them is omitted from the RA report, and if the triggering feature combination and the used feature combination are different then they are both included in the RA report.

20.-21. (canceled)

22. The method of claim 19, wherein the triggering feature combination and/or used feature combination is included in one of the following ways: once in an RA-Report-r16 Information Element, IE; once per RA procedure; in a top level of the RA-Report-r16 IE or in the RA-InformationCommon-r16 IE; per RA attempt in an RA-Report-r16 IE; in the PerRAAttemptInfo-r16 IE.

23. The method of claim 19, wherein the triggering feature combination changes during a plurality of RA attempts.

24. The method of claim 19, wherein the triggering feature combination and/or used feature combination is included at a per-RA attempt level in a RA-Report-r16 Information Element, IE, and;
if the triggering feature combination and used feature combination are unchanged since the preceding RA attempt, it is omitted in a PerRAAttemptInfo-r16 IE corresponding to a subsequent RA attempt; and
if the triggering feature combination and/or used feature combination are changed for a RA attempt then the triggering feature combination and/or used feature combination are included in the PerRAAttemptInfo-r16 IE representing the first RA attempt in a RA procedure, and then included in any subsequent PerRAAttemptInfo-r16 IE in the same RA procedure.

25. The method of claim 19, wherein the triggering feature combination and/or used feature combination is included in at least one of: a RA-Report-r16 Information Element, IE; or a RA-InformationCommon-r16 IE; and wherein any subsequent change of the triggering feature combination and/or used feature combination in a subsequent RA attempt is indicated in a PerRAAttemptInfo-r16 IE representing the RA attempt where the subsequent change occurred.

26.-33. (canceled)

34. The method of claim 19, further comprising transmitting (2050), to the UE, a request for RA related information.

35.-37. (canceled)

38. A user equipment, UE, for optimizing random access, RA, configuration, the UE comprising:
an antenna configured to send and receive wireless signals;
radio front-end circuitry connected to the antenna and to processing circuitry, and configured to condition signals communicated between the antenna and the processing circuitry;
the processing circuitry being configured to:
detect a trigger condition to initiate an RA procedure, the trigger condition based on a triggering feature combination comprising a first one or more features; and
select an RA preamble from an RA preamble partition, the RA preamble partition associated with a used feature combination comprising a second one or more features; and
wherein the radio front-end circuitry and antenna are configured to transmitting a RA report to a network node, wherein when the triggering feature combination and the used feature combination are the same then one of them is omitted from the RA report, and if the triggering feature combination and the used feature combination are different then they are both included in the RA report
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

39. (canceled)

40. The UE of claim 38, wherein the triggering feature combination and/or used feature combination is included at a per-RA attempt level in a RA-Report-r16 Information Element, IE, and;
if the triggering feature combination and used feature combination are unchanged since the preceding RA attempt, it is omitted in a PerRAAttemptInfo-r16 IE corresponding to a subsequent RA attempt; and
if the triggering feature combination and/or used feature combination are changed for a RA attempt then the triggering feature combination and/or used feature combination are included in the PerRAAttemptInfo-r16 IE representing the first RA attempt in a RA procedure, and then included in any subsequent PerRAAttemptInfo-r16 IE in the same RA procedure.

41. The UE of claim 38, wherein the triggering feature combination and/or used feature combination is included in at least one of: a RA-Report-r16 Information Element, IE; or a RA-InformationCommon-r16 IE; and wherein any subsequent change of the triggering feature combination and/or used feature combination in a subsequent RA attempt is indicated in a PerRAAttemptInfo-r16 IE representing the RA attempt where the subsequent change occurred.

42. The UE of claim 38, wherein any changes in the triggering feature combination and/or used feature combination during a RA procedure are ignored in the RA report and only a final triggering feature combination and/or used feature combination is reported in a subsequent RA report.

43. The UE of claim 38, wherein the radio front-end circuitry and antenna are further configured to receive from a network a request for RA related information.
